(19) United States
(12) Patent Application Publication
(10) Pub. No.: US 2025/0210691 A1
(43) Pub. Date: Jun. 26, 2025

(54) SOLID ELECTROLYTE, ELECTROCHEMICAL DEVICE INCLUDING THE SOLID ELECTROLYTE, AND METHOD OF PREPARING THE SOLID ELECTROLYTE

(71) Applicant: Samsung SDI Co., Ltd., Yongin-si (KR)

(72) Inventor: Wonsung Choi, Suwon-si (KR)

(21) Appl. No.: 18/788,400

(22) Filed: Jul. 30, 2024

(30) Foreign Application Priority Data
Dec. 26, 2023 (KR) 10-2023-0191854

(51) Int. Cl. H01M 10/0562; H01G 11/56; H01G 11/84

(52) U.S. Cl. CPC H01M 10/0562; H01G 11/56; H01G 11/84; H01M 2300/0071; H01M 2300/008; H01M 2300/0091; H01M 2300/0094

(57) ABSTRACT

A solid electrolyte including a mixed solid ion conductor with a metal nitrate or a hydrate thereof. The metal of the metal nitrate is one or more of an M metal or an M′ metal, the M metal is a monovalent cationic metal, and the M′ metal is one or more of a divalent cationic metal, a trivalent cationic metal, a tetravalent cationic metal, a pentavalent cationic metal or a hexavalent cationic metal. Also disclosed are an electrochemical device including the solid electrolyte, and a method of preparing the solid electrolyte.

### CROSS-REFERENCE TO RELATED APPLICATION

This application is based on and claims priority to Korean Patent Application No. 10-2023-0191854, filed on Dec. 26, 2023, in the Korean Intellectual Property Office, and all the benefits accruing therefrom under 35 U.S.C. § 119, the content of which is herein incorporated by reference in its entirety.

### BACKGROUND

### 1. Field

This disclosure relates to a solid electrolyte, an electrochemical device including the solid electrolyte, and a method of preparing the solid electrolyte.

### 2. Description of the Related Art

Electrochemical devices, for example, all-solid secondary batteries typically employ lithium metal or the like with high energy density as a negative electrode to achieve a high energy density, and use a solid ion conductor as an electrolyte for safe operation.

As solid ion conductors, oxide solid ion conductors, sulfide solid ion conductors, and halide solid ion conductors are being widely studied depending on the type of anion. Although oxide solid ion conductors have high chemical stability, generally their performance is inferior to that of sulfide solid ion conductors in terms of ion conductivity and moldability. Sulfide solid ion conductors have high ion conductivity and excellent moldability, but they react with water to generate toxic gas. Halide solid ion conductors do not generate toxic gas and are highly adaptable to the environment, but they often provide unsatisfactory ion conductivity or lack stability in assembled batteries.

Therefore, there is still a need for a solid electrolyte with a composition with excellent ion conductivity and flexibility but also electrochemical stability, an electrochemical device including the same, and a method of preparing the solid electrolyte.

### SUMMARY

Provided is a solid electrolyte that not only has excellent ion conductivity and flexibility, but also has electrochemical stability.

Provided is an electrochemical device including the solid electrolyte.

Provided is a method of preparing the solid electrolyte.

Additional aspects will be set forth in part in the description which follows and, in part, will be apparent from the description, or may be learned by practice of the presented embodiments of the disclosure.

According to an embodiment, the solid electrolyte includes a mixed solid ion conductor which includes a metal nitrate or a hydrate thereof,
wherein the metal of the metal nitrate is one or more of an M metal or an M′ metal,
the M metal is a monovalent cationic metal, and
the M′ metal is one or more of a divalent cationic metal, a trivalent cationic metal, a tetravalent cationic metal, a pentavalent cationic metals, or a hexavalent cationic metal.

According to an embodiment, the M metal may be Li, Na, K, Rb, Cs, or Fr.

According to an embodiment, the M′ metal may include one or more of La, Ce, Pr, Nd, Pm, Sm, Eu, Gd, Tb, Dy, Ho, Er, Tm, Yb, Lu, Sc, Y, Ti, Zr, Hf, V, Nb, Ta, Al, Ga, or In.

According to an embodiment, the melting point of the metal nitrate or the hydrate thereof may be about 0° C. to about 100° C.

According to an embodiment, the metal nitrate or the hydrate thereof may include one or more of La(NO₃)₃, La(NO₃)₃·6H₂O, LiNO₃, NaNO₃, KNO₃, RbNO₃, CsNO₃, FrNO₃, Ce(NO₃)₃, Ce(NO₃)₃·6H₂O, Pr(NO₃)₃, Pr(NO₃)₃·6H₂O, Nd(NO₃)₃, Nd(NO₃)₃·6H₂O, Pm(NO₃)₃, Pm(NO₃)₃·6H₂O, Sm(NO₃)₃, Sm(NO₃)₃·6H₂O, Eu(NO₃)₃, Eu(NO₃)₃·6H₂O, Ga(NO₃)₃, Ga(NO₃)₃·6H₂O, Tb(NO₃)₃, Tb(NO₃)₃·6H₂O, Dy(NO₃)₃, Dy(NO₃)₃·6H₂O, Ho(NO₃)₃, Ho(NO₃)₃·5H₂O, Er(NO₃)₃, Er(NO₃)₃·5H₂O, Tm(NO₃)₃, Tm(NO₃)₃·5H₂O, Tm(NO₃)₃·6H₂O, Yb(NO₃)₃, Yb(NO₃)₃·5H₂O, Lu(NO₃)₃, Lu(NO₃)₃·5H₂O, Lu(NO₃)₃·6H₂O, Sc(NO₃)₃, SC(NO₃)₃·6H₂O, Y(NO₃)₃, Y(NO₃)₃·6H₂O, Ti(NO₃)₄, Zr(NO₃)₄, Hf(NO₃)₄, V(NO₃)₃, Nb(NO₃)₃, Nb(NO₃)₃·6H₂O, Ta(NO₃)₃, Al(NO₃)₃, Al(NO₃)₃·9H₂O, In(NO₃)₃, Li₂La(NO₃)₅, Li₂Ce(NO₃)₅, Li₂Pr(NO₃)₅, Li₂Nd(NO₃)₅, Li₂Pm(NO₃)₅, Li₂Sm(NO₃)₅, Li₂Eu(NO₃)₅, Li₂Ga(NO₃)₅, Li₂Tb(NO₃)₅, Li₂Dy(NO₃)₅, Li₂Ho(NO₃)₅, Li₂Er(NO₃)₅, Li₂Tm(NO₃)₅, Li₂Tm(NO₃)₅, Li₂Yb(NO₃)₅, Li₂Lu(NO₃)₅, Li₂Sc(NO₃)₅, Li₂Y(NO₃)₅, Li₂V(NO₃)₅, Li₂Nb(NO₃)₅, Li₂Ta(NO₃)₅, Li₂Al(NO₃)₅, or Li₂In(NO₃)₅.

According to an embodiment, the metal nitrate may include a crystal structure belonging to a Pnnm space group.

According to an embodiment, the distance between lithium and oxygen in the crystal structure may be about 2.0 angstroms (Å) to about 3.0 Å.

According to an embodiment, the amount of the metal nitrate or the hydrate thereof may be about 50 weight percent (wt %) to about 100 wt %, based on the total weight of the mixed solid ion conductor.

According to an embodiment, the solid electrolyte may further include a metal compound different than the metal nitrate or the hydrate thereof, wherein the metal compound is represented by the formula MₐX, X is a monovalent, divalent, trivalent, tetravalent or pentavalent anionic element or polyatomic anion comprising the monovalent, divalent, trivalent, tetravalent or pentavalent anionic element, wherein X is other than F⁻, Cl⁻, Br⁻, or I⁻, and a is an integer of 1 to 5.

According to an embodiment, X may include O²⁻, (PO₄)⁻, (SO₄)⁻, [N(SO₃CF₃)₂]⁻, OH⁻, (CO₃), (BO₃)⁻, (TiO₃)⁻, or (TaO₃)⁻.

According to an embodiment, the metal compound may include one or more of Li₃PO₄, Li₂O, Li₂SO₄, LiN(SO₃CF₃)₂, LiOH, Li₂CO₃, Li(BO₃)₃, LiTiO₃, LiTaO₃, Na₃PO₄, Na₂O, Na₂SO₄, NaN(SO₃CF₃)₂, NaOH, Na₂CO₃, Na(BO₃)₃, NaTiO₃, NaTaO₃, K₃PO₄, K₂O, K₂SO₄, KN(SO₃CF₃)₂, KOH, K₂CO₃, K(BO₃)₃, KTiO₃, KtaO₃, Rb₃PO₄, Rb₂O, Rb₂SO₄, RbN(SO₃CF₃)₂, RbOH, Rb₂CO₃, Rb(BO₃)₃, RbTiO₃, RbTaO₃, Cs₃PO₄, CS₂O, CS₂SO₄, CsN(SO₃CF₃)₂, CsOH, CS₂CO₃, Cs(BO₃)₃, CsTiO₃, CsTaO₃, Fr₃PO₄, Fr₂O, Fr₂SO₄, FrN(SO₃CF₃)₂, FrOH, Fr₂CO₃, Fr(BO₃)₃, FrTiO₃, or FrTaO₃.

According to an embodiment, the mixed solid ion conductor of the solid electrolyte may include an amorphous phase.

According to an embodiment, the mixed solid ion conductor may have an ion conductivity at 25° C. of the solid electrolyte may be 5×10⁻⁵ siemens per centimeter (S/cm) to 2×10⁻³ S/cm.

According to an embodiment, a positive electrode may include the solid electrolyte.

According to another embodiment, the electrochemical device may include a positive electrode layer; a negative electrode layer, and a solid electrolyte layer between the positive electrode layer and the negative electrode layer, and one or more of a positive electrode layer, a negative electrode layer or a solid electrolyte layer may include the solid electrolyte.

According to an embodiment, the positive electrode layer may include a positive electrode active material and the solid electrolyte, and the solid electrolyte layer may include the solid electrolyte and further include a solid electrolyte with one ore more of sulfide solid electrolyte, an oxide solid electrolyte, or a polymer solid electrolyte.

According to an embodiment, the positive electrode layer may further include a conductive material, and the conductive material may include one or more of graphite particles, carbon nanotube particles, and carbon nanofiber particles.

According to an embodiment, the oxide solid electrolyte may include one or more of Li_{1+x+y}AlₓTi₂₋ₓSi_{y}P_{3-y}O₁₂ wherein 0<x<2 and 0≤y<3, BaTiO₃, Pb(ZrₓTi₁₋ₓ)O₃ (PZT) wherein O≤x≤1, Pb₁₋ₓLaₓZr_{1-y}Ti_{y}O₃ (PLZT) wherein 0≤x<1 and 0≤y<1, Pb(Mg₃Nb_{2/3})O₃—PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, Li₃PO₄, LiₓTi_{y}(PO₄)₃ wherein 0<x<2 and 0<y<3, LiₓAl_{y}Ti_{z}(PO₄)₃ wherein 0<x<2, 0<y<1, and 0<z<3, Li_{1+x+y}(AlₐGa₁₋ₐ)ₓ(Ti_{b}Ge_{1-b})₂₋ₓSi_{y}P_{3-y}O₁₂ wherein O≤x≤1, 0≤y≤1, 0≤a≤1, and 0≤b≤1, LiₓLa_{y}TiO₃ wherein 0<x<2 and 0<y<3, Li₂O, LiOH, Li₂CO₃, LiAlO₂, Li₂O—Al₂O₃—SiO₂—P₂O₅ —TiO₂—GeO₂, or Li₃₊ₓLa₃M₂O₁₂ wherein M═Te, Nb or Zr, and x is an integer of 1 to 10.

According to an embodiment, the sulfide-based solid electrolyte may include a compound represented by the following Formula 4.

LiₐM′5ₓPS_{y}M′6_{z}M′7_{w} Formula 4

In Formula 4, M′5 may be one or more metal elements other than Li and selected from Groups 1 to 15 of the Periodic Table of the Elements, and M′6 may be one or more elements selected from Group 17 of the Periodic Table of the Elements,
M′7 may be SOₙ, and 4≤a≤8, 0≤x<1, 3≤y≤7, 0<z≤5, 0≤w<2, and 1.5≤n≤5.

According to an embodiment, the electrochemical device may be an electrochemical cell, a storage battery, a super capacitor, a fuel cell, a sensor, or an electrochromic device.

According to another embodiment, a method of preparing a solid electrolyte may include preparing a raw material of one or more of a metal nitrate or a hydrate thereof,
mechanically milling the raw material to provide a mixture, and
molding the mixture to prepare the solid electrolyte.

According to an embodiment, the method may further include adding a metal compound different than the metal nitrate or the hydrate thereof to the raw material and mixing, wherein the metal compound may be represented by formula MaX, and X may be a monovalent, divalent, trivalent, tetravalent or pentavalent anionic element or a polyatomic anion comprising the monovalent, divalent, trivalent, tetravalent or pentavalent anionic element. X may be other than F⁻, C⁻, Br⁻, or I, and a may be an integer of 1 to 5.

According to an embodiment, mechanically milling may comprise one or more of ball milling, airjet milling, bead milling, roll milling, hand milling, high energy ball milling, planetary mill ball milling, stirred ball milling, vibrating milling, mechanofusion milling, shaker milling, planetary milling, attritor milling, disk milling, shape milling, nauta milling, nobilta milling, or high speed mixing.

According to an embodiment, mechanically milling may comprise planetary milling and performed at room temperature.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1A is a schematic diagram illustrating an embodiment of the crystal structure of a metal nitrate;

FIG. 1B is a schematic diagram illustrating another embodiment of the crystal structure of a metal nitrate and a Li⁺ channel within the crystal structure;

FIGS. 2 to 4 are cross-sectional views of an embodiment of an all-solid secondary battery, respectively;

FIG. 5 is a photograph of flexibility test for a mixed solid ion conductor of La(NO₃)₃, Li₃PO₄, 2LiNO₃, and Li₂O prepared in Example 1;

FIG. 6 is a graph of intensity (arbitrary units, a.u.) versus diffraction angle (degrees 2θ) showing results of an X-ray diffraction (XRD) analysis using CuK a rays for the mixed solid ion conductor of La(NO₃)₃, Li₃PO₄, 2LiNO₃, and Li₂O prepared in Example 1.

FIG. 7 is a graph of imaginary impedance (ohm-square centimeters) versus real impedance (ohm-square centimeters) at 25° C. and 0° C. for a lithium symmetric cell with a lithium/solid electrolyte/lithium structure prepared using mixed solid ion conductor pellets of La(NO₃)₃, Li₃PO₄, 2LiNO₃, and Li₂O prepared in Example 1 as a solid electrolyte;

FIG. 8 is graph of conductivity (seimens per centimeter, Scm⁻¹) versus temperature (° C. and 1000/Temperature in Kelvins, 1000/K) of a platinum (Pt) electrode structure formed on both sides of the mixed solid ion conductor pellets of La(NO₃)₃, Li₃PO₄, 2LiNO₃, and Li₂O prepared in Example 1; and

FIG. 9 is a graph of voltage (volts, V) versus capacity (milliampere-hour per square centimeters, mAh·cm⁻²) and shows the initial charge/discharge test results for an all-solid secondary battery prepared in Example 11.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

The inventive concept described below can be subjected to various transformations and can have various embodiments, and specific embodiments are illustrated in the drawings and described in detail in the detailed description. However, this is not intended to limit the inventive concept to a specific embodiment, and should be understood to include all transformations, equivalents, or substitutes included in the technical scope of the inventive concept.

The terms used below are only used to describe specific embodiments and are not intended to limit the inventive concept. Singular expressions include plural expressions unless the context clearly dictates otherwise.

In this disclosure, the expression “at least one type”, “one or more types”, or “one or more”, when preceding a list of elements, modify the entire list of elements and do not modify the individual elements of the list. For example, “at least one of A, B, or C,” and similar phrases (e.g., “at least one selected from the group consisting of A, B, and C” or “one or more selected from A, B, or C”) may indicate only A, only B, only C, or a combination of at least two or more of A, B, and C, such as ABC, AB, BC, and AC.

In the disclosure, the term “combination” includes mixtures, alloys, reaction products, etc., unless specifically stated otherwise. In this disclosure, the term “including” means that other components may be further included rather than excluding other components, unless specifically stated to the contrary.

In the disclosure, terms such as “first” and “second” do not indicate order, quantity, or importance, but are used to distinguish one element from another element. Unless otherwise indicated herein or clearly contradicted by context, the singular forms are intended to include both the singular and the plural forms. “Or” means “and/or” unless otherwise specified.

In this disclosure, components referred to as “on,” “top,” “above,” “upper,” etc. of other components may be located in direct contact with other components, or there may be components interposed therebetween.

Throughout this disclosure, references to “an embodiment,” “embodiments” etc. mean that a particular element described in connection with an Example is included in at least one Example described herein and may or may not exist in other Examples. Additionally, it should be understood that the elements described may be combined in any suitable way in various embodiments.

Unless otherwise stated, all percentages, parts, ratios, etc. are by weight. Additionally, when an amount, concentration, or other value or parameter is given either as a range, a preferred range, or a list of upper and lower preferred values, it is to be understood that all ranges formed from any pair of any upper range limit or preferred value and any lower range limit or preferred value are to be specifically disclosed, regardless of whether the ranges are separately disclosed.

When a range of numerical values is stated herein, unless otherwise stated, the range is intended to include the endpoints and all integers and fractions within the range. The scope of the disclosure is not intended to be limited to the specific values recited when defining the scope.

Unless otherwise specified, the unit “part by weight” refers to the weight ratio between each component, and the unit “part by mass” refers to the value obtained by converting the weight ratio between each component into solid amount.

As used herein, the term “about” or “substantially” includes the stated value and means within the range of acceptable deviations from that particular value as determined by a person skilled in the art, taking into account the errors associated with the measurement and the measurement of a particular quantity. (i.e. limitations of the measurement system). For example, “about” or “substantially” may mean within one or more standard deviations, or within ±30%, 20%, 10%, or 5% of the specified value.

Unless otherwise defined, all terms (including technical terms and scientific terms) used herein have the same meaning as commonly understood by a person skilled in the art to which this disclosure pertains. Additionally, it will be understood that terms such as terms defined in commonly used dictionaries should be construed as having meanings consistent with their meanings in the context of the related art and the present disclosure, and will not be construed as idealized. Also, the terms will not be interpreted in an overly formal sense.

Exemplary embodiments are described herein with reference to cross-sectional views, which are schematic diagrams of idealized embodiments. As such, variations from the shapes of the illustrations as a result, for example, of manufacturing techniques and/or tolerances, are to be expected. Accordingly, the embodiments described herein should not be construed as being limited to the particular shapes of the regions described herein, but are not to include deviations in shapes that result, for example, from manufacturing. For example, a region illustrated or described as flat may, typically, have rough and/or nonlinear features. Moreover, sharp angles that are illustrated may be rounded. Thus, the regions illustrated in the drawings are schematic in nature and their shapes are not intended to illustrate the precise shape of a region and are not intended to limit the scope of the claims.

In general, electrochemical devices, such as all-solid secondary batteries, do not use a liquid electrolyte, to prevent safety problems due to flammability and evaporation, and decomposition by reaction with lithium metal. However, solid electrolytes for all-solid secondary batteries typically cannot achieve ionic conductivity as high as liquid electrolytes, and are therefore inferior in terms of charge/discharge characteristics compared to lithium-ion batteries.

Recently, halide-based solid ion conductors have attracted attention as solid ion conductors for solid electrolytes. Halide-based solid electrolytes have mechanical flexibility and non-flammability, and may be molded in various ways by simple pressurization. Li₃InCl₆ and Li₃YCl₆ are known examples of halide-based solid electrolytes. However, such halide-based solid electrolytes as solid ion conductors generally fail to provide satisfactory levels of ionic conductivity and battery stability.

Disclosed herein is a solid electrolyte with a novel composition with the flexibility level of a halide-based solid electrolyte and the electrochemical stability of an oxide solid electrolyte, an electrochemical device including the same, and a method of preparing the solid electrolyte.

Hereinafter, a solid electrolyte according to embodiments, an electrochemical device including the same, and a method of preparing the solid electrolyte will be described in more detail.

### Solid Electrolyte

A solid electrolyte according to an embodiment may include a mixed solid ion conductor. The solid electrolyte may be in the form of powder or molded products. The solid electrolyte molded products may be in the form of pellets, sheets, thin films, etc. For example, the solid electrolyte may be in the form of pellets. However, the molded products of the solid electrolyte are not limited to these and may be manufactured in various forms depending on the purpose.

The solid electrolyte according to an embodiment may include a mixed solid ion conductor which includes a metal nitrate or a hydrate thereof, wherein the metal of the metal nitrate is one or more of an M metal or an M′ metal, the M metal is a monovalent cationic metal, and the M′ metal is a divalent, trivalent, tetravalent, pentavalent or hexavalent cationic metal.

According to an embodiment, the M metal may be Li, Na, K, Rb, Cs, or Fr. For example, the M metal may be Li, Na, or K.

According to an embodiment, the M′ metal may include one or more of La, Ce, Pr, Nd, Pm, Sm, Eu, Gd, Tb, Dy, Ho, Er, Tm, Yb, Lu, Sc, Y, Ti, Zr, Hf, V, Nb, Ta, Al, Ga, or In. For example, the M′ metal may include one or more of La, Ce, Pr, Nd, Pm, Sm, Eu, Gd, Tb, Dy, Ho, Er, Tm, Yb, or Lu.

According to an embodiment, the melting point of the metal nitrate or the hydrate thereof may be about 0° C. to about 100° C. For example, the melting point of the metal nitrate or the hydrate thereof may be about 10° C. to about 100° C., or about 20° C. to about 90° C., or about 30° C. to about 80° C., or about 40° C. to about 80° C. Such metal nitrate or a hydrate thereof may provide a solid electrolyte with flexibility when mixed with a compound including other metal salts.

According to an embodiment, the metal nitrate or the hydrate thereof may include one or more of La(NO₃)₃, La(NO₃)₃·6H₂O, LiNO₃, NaNO₃, KNO₃, RbNO₃, CsNO₃, FrNO₃, Ce(NO₃)₃, Ce(NO₃)₃·6H₂O, Pr(NO₃)₃, Pr(NO₃)₃·6H₂O, Nd(NO₃)₃, Nd(NO₃)₃·6H₂O, Pm(NO₃)₃, Pm(NO₃)₃·6H₂O, Sm(NO₃)₃, Sm(NO₃)₃·6H₂O, Eu(NO₃)₃, Eu(NO₃)₃·6H₂O, Ga(NO₃)₃, Ga(NO₃)₃·6H₂O, Tb(NO₃)₃, Tb(NO₃)₃·6H₂O, Dy(NO₃)₃, Dy(NO₃)₃·6H₂O, Ho(NO₃)₃, Ho(NO₃)₃·5H₂O, Er(NO₃)₃, Er(NO₃)₃·5H₂O, Tm(NO₃)₃, Tm(NO₃)₃·5H₂O, Tm(NO₃)₃·6H₂O, Yb(NO₃)₃, Yb(NO₃)₃·5H₂O, Lu(NO₃)₃, Lu(NO₃)₃·5H₂O, Lu(NO₃)₃·6H₂O, Sc(NO₃)₃, Sc(NO₃)₃·6H₂O, Y(NO₃)₃, Y(NO₃)₃·6H₂O, Ti(NO₃)₄, Zr(NO₃)₄, Hf(NO₃)₄, V(NO₃)₃, Nb(NO₃)₃, Nb(NO₃)₃·6H₂O, Ta(NO₃)₃, Al(NO₃)₃, Al(NO₃)₃·9H₂O, In(NO₃)₃, Li₂La(NO₃)₅, Li₂Ce(NO₃)₅, Li₂Pr(NO₃)₅, Li₂Nd(NO₃)₅, Li₂Pm(NO₃)₅, Li₂Sm(NO₃)₅, Li₂Eu(NO₃)₅, Li₂Ga(NO₃)₅, Li₂Tb(NO₃)₅, Li₂Dy(NO₃)₅, Li₂Ho(NO₃)₅, Li₂Er(NO₃)₅, Li₂Tm(NO₃)₅, Li₂Tm(NO₃)₅, Li₂Yb(NO₃)₅, Li₂Lu(NO₃)₅, Li₂Sc(NO₃)₅, Li₂Y(NO₃)₅, Li₂V(NO₃)₅, Li₂Nb(NO₃)₅, Li₂Ta(NO₃)₅, Li₂Al(NO₃)₅, or Li₂In(NO₃)₅.

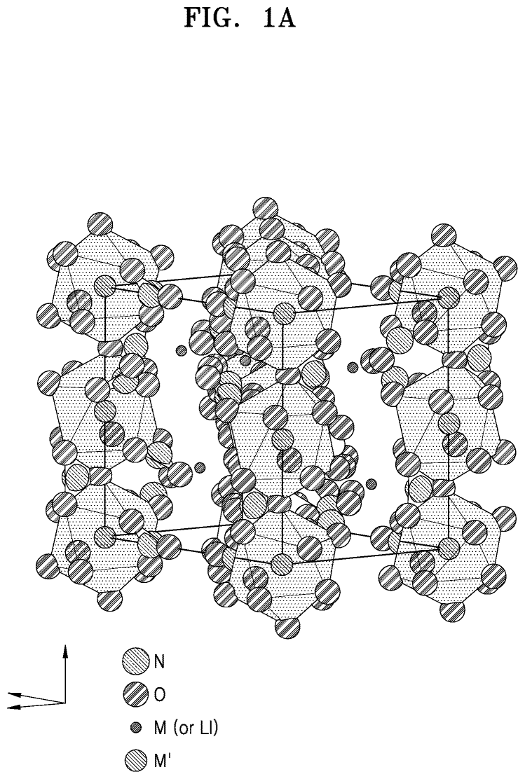

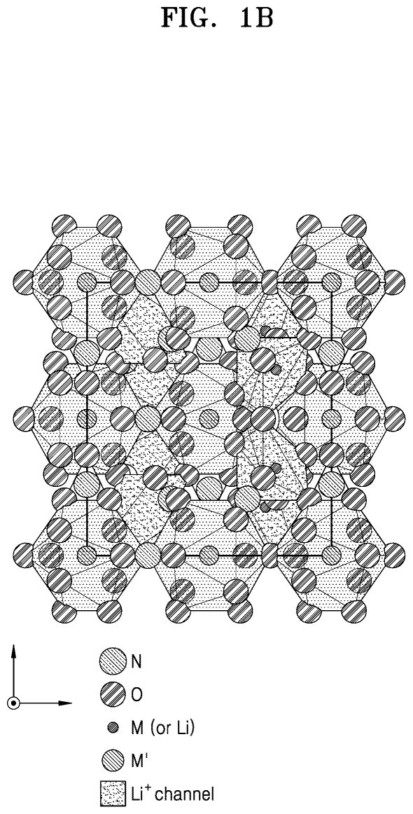

FIG. 1A is a schematic diagram illustrating the crystal structure of a metal nitrate according to an embodiment. FIG. 1B is a schematic diagram illustrating the crystal structure of a metal nitrate according to another embodiment and a Li⁺ channel within the crystal structure.

Referring to FIG. 1A, the metal nitrate according to an embodiment may include a crystal structure belonging to a Pnnm space group. The metal nitrate may be MM′(NO₃)₅, for example, Li₂La(NO₃)₅. The metal nitrate is composed of a dodecahedron centered on the M′ metal (e.g. La³⁺) and coordinated by eight nitrates, and is a crystal structure belonging to a Pnnm space group in which monovalent cationic M metal (e.g., Li⁺) is positioned around the dodecahedron. The orthorhombic crystal structure forms Li⁺ channels (filled portions) therein. The M metal (e.g., Li⁺) may have a Li₂O ionic bond depending on its distance from O²⁻. In the orthorhombic crystal structure, the distance between lithium and oxygen may be about 2.0 Å to about 3.0 Å. For example, in the orthorhombic crystal structure, the distance between lithium and oxygen may be 2.2 Å. A metal nitrate with such a crystal structure may have excellent ionic conductivity.

According to an embodiment, the amount of the metal nitrate or the hydrate thereof may be about 50 wt % to about 100 wt %, based on the total weight of the mixed solid ion conductor. If the amount of the metal nitrate or the hydrate thereof is within the above range, it may have excellent ionic conductivity and flexibility as well as electrochemical stability.

According to an embodiment, the solid electrolyte may further include a metal compound other than the metal nitrate or the hydrate thereof, wherein the metal compound may be represented by formula MₐX, wherein X may be a monovalent, divalent, trivalent, tetravalent or pentavalent anionic element or polyatomic anion comprising the monovalent, divalent, trivalent, tetravalent or pentavalent anionic element, X may be other than F⁻, Cl⁻, Br⁻, or I⁻, and a may be an integer of 1 to 5. The metal compound may be mixed with the metal nitrate or the hydrate thereof to have better ionic conductivity and flexibility as well as improved electrochemical stability.

According to an embodiment, X may include O²⁻, (PO₄)⁻, (SO₄)⁻, [N(SO₃CF₃)₂]⁻, OH⁻, (CO₃)⁻, (BO₃)⁻, (TiO₃)⁻, or (TaO₃)⁻. For example, X may include O₂⁻, (PO₄)⁻, (SO₄)⁻, OH⁻, (CO₃)⁻, or (BO₃)⁻.

According to an embodiment, the metal compound may include one or more of Li₃PO₄, Li₂O, Li₂SO₄, LiN(SO₃CF₃)₂, LiOH, Li₂CO₃, Li(BO₃)₃, LiTiO₃, LiTaO₃, Na₃PO₄, Na₂O, Na₂SO₄, NaN(SO₃CF₃)₂, NaOH, Na₂CO₃, Na(BO₃)₃, NaTiO₃, NaTaO₃, K₃PO₄, K₂O, K₂SO₄, KN(SO₃CF₃)₂, KOH, K₂CO₃, K(BO₃)₃, KTiO₃, KTaO₃, Rb₃PO₄, Rb₂O, Rb₂SO₄, RbN(SO₃CF₃)₂, RbOH, Rb₂CO₃, Rb(BO₃)₃, RbTiO₃, RbTaO₃, Cs₃PO₄, CS₂O, CS₂SO₄, CsN(SO₃CF₃)₂, CsOH, CS₂CO₃, Cs(BO₃)₃, CsTiO₃, CsTaO₃, Fr₃PO₄, Fr₂O, Fr₂SO₄, FrN(SO₃CF₃)₂, FrOH, Fr₂CO₃, Fr(BO₃)₃, FrTiO₃, or FrTaO₃. For example, the metal compound may include one or more of Li₃PO₄, Li₂O, Li₂SO₄, LiN(SO₃CF₃)₂, LiOH, Li₂CO₃, Li(BO₃)₃, LiTiO₃, LiTaO₃, Na₃PO₄, Na₂O, Na₂SO₄, NaN(SO₃CF₃)₂, NaOH, Na₂CO₃, Na(BO₃)₃, NaTiO₃, NaTaO₃, K₃PO₄, K₂O, K₂SO₄, KN(SO₃CF₃)₂, KOH, K₂CO₃, K(BO₃)₃, KTiO₃, or KTaO₃.

According to an embodiment, the solid electrolyte may include an amorphous phase. The solid electrolyte may be the amorphized product resulting from the reaction of solid raw materials. This may be confirmed by X-ray diffraction analysis using Cu Kα rays, which will be described later.

According to an embodiment, the solid electrolyte may have an ionic conductivity of about 5×10⁻⁵ S/cm to about 2×10⁻³ S/cm, about 5.3×10⁻⁵ S/cm to about 1.8×10⁻³ S/cm, or about 5.5×10⁻⁵ S/cm to about 1.6×10⁻³ S/cm at 25° C.

According to an embodiment, the solid electrolyte may have an activation energy of about 0.1 electronvolts (eV) to about 0.36 eV at 25° C.

### Electrochemical Device

According to another embodiment, a positive electrode includes a solid electrolyte.

According to another embodiment, an electrochemical device may include a positive electrode layer, a negative electrode layer, and a solid electrolyte layer between the positive electrode layer and the negative electrode layer, and may include the solid electrolyte.

The solid electrolyte according to an embodiment may be included in the positive electrode layer, the negative electrode layer, the solid electrolyte layer, a protective film of the positive electrode layer, a protective film of the negative electrode layer, or a combination thereof.

The electrochemical device according to an embodiment may be an electrochemical cell, a storage battery, a super capacitor, a fuel cell, a sensor, or an electrochromic device. For example, the electrochemical device may be an electrochemical cell. For example, the electrochemical cell may be an all-solid secondary battery.

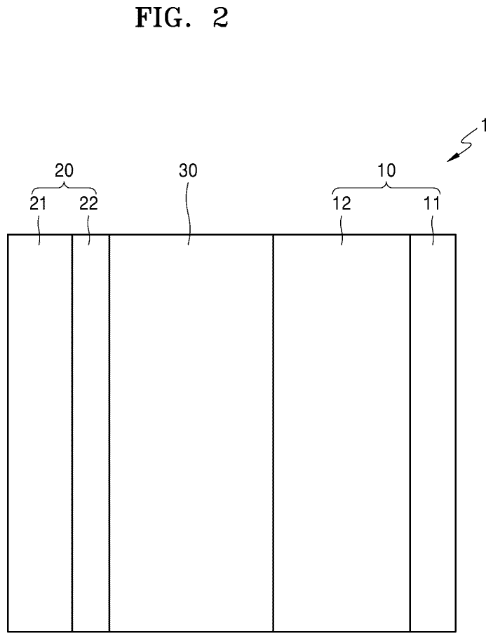

FIGS. 2 to 4 are cross-sectional views of an all-solid secondary battery according to an embodiment.

Referring to FIGS. 2 to 4, the all-solid secondary battery 1 includes: a positive electrode layer 10 including a positive electrode current collector 11 and a positive electrode active material layer 12; a negative electrode layer 20; and a solid electrolyte layer 30 disposed between the positive electrode layer 10 and the negative electrode layer 20. The negative electrode layer 20 includes a negative electrode current collector 21 and a negative electrode active material layer 22 disposed on the negative electrode current collector 21, wherein the negative electrode active material layer 22 includes a negative electrode active material that includes lithium metal or a lithium alloy. One or more of the positive electrode layer 10, the negative electrode layer 20, or the solid electrolyte layer 30 of the all-solid secondary battery 1 includes a solid ion conductor.

The positive electrode layer 10 according to an embodiment may include a positive electrode active material and the solid electrolyte, and the solid electrolyte layer 30 may include a solid electrolyte selected from a sulfide solid electrolyte, an oxide solid electrolyte, a polymer solid electrolyte, or a combination thereof.

The positive electrode layer 10 according to an embodiment may include a positive electrode active material and the solid electrolyte, and the solid electrolyte layer 30 may further include a solid electrolyte selected from a sulfide solid electrolyte, an oxide-based solid electrolyte, a polymer solid electrolyte, or a combination thereof, in addition to the solid electrolyte. The solid electrolyte layer 30 may be a single layer or a plurality of layers.

For the positive electrode current collector 11, a metal substrate may be used. Examples of the metal substrate are plates or foils composed of indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof. The positive electrode current collector 11 may be omitted.

The positive electrode active material layer 12 is a layer derived from a composition including a positive electrode active material and/or a solid electrolyte. The solid electrolyte included in the positive layer 10 may be the same as or different from the solid electrolyte included in the solid electrolyte layer 30. For example, the positive electrode active material layer 12 may include a solid electrolyte including the mixed solid ion conductor.

Any positive electrode active material may be used without limitation as long as it is commonly used in all-solid secondary batteries 1, 1a. For example, one or more of complex oxides of lithium and a metal selected from cobalt, manganese, nickel, and a combination thereof may be used as a positive electrode active material. For a specific example, a compound represented by any one of Formulae of LiₐA_{1-b}B′_{b}D′₂ (wherein 0.90≤a≤1.8 and 0≤b≤0.5), LiₐE_{1-b}B′_{b}O_{2-c}D′_{c} (where 0.90≤a≤1.8, 0≤5 b≤0.5, and 0≤c≤0.05), LiE_{2-b}B′_{b}O_{4-c}D′_{c} (wherein 0≤b≤0.5 and 0≤c≤0.05), LiₐNi_{1-b-c}Co_{b}B′_{c}D′ₐ (wherein 0.90≤a≤1.8, 0≤b≤0.5, 0≤c≤0.05, and 0<α≤2), LiₐNi_{1-b-c}Co_{b}B′_{c}O₂−αF′α (wherein 0.90≤a≤1.8, 0≤b≤0.5, 0≤c≤0.05, and 0<α<2), LiₐNi_{1-b-c}Co_{b}B′_{c}O₂−αF′₂ (wherein 0.90≤a≤1.8, 0≤b≤0.5, 0≤c≤0.05, and 0<a<2), LiₐNi_{1-b-c}MₙbB′_{c}D′_{α} (wherein 0.90≤a≤1.8, 0≤b≤0.5, 0≤c≤0.05, and 0<α≤2), LiₐNi_{1-b-c}Mn_{b}B′_{c}O_{2-α}F′α (wherein 0.90≤a≤1.8, 0≤b≤0.5, 0≤c≤0.05, and 0<α<2), LiₐNi_{1-b-c}Mn_{b}B′_{c}O_{2-α}F′₂ (wherein 0.90≤a 1.8, 0≤5 b≤0.5, 0<5 c≤0.05, and 0≤α≤2), LiₐNi_{b}E_{c}G_{d}O₂ (wherein 0.90≤a≤1.8, 0≤5 b≤0.9, 0≤5 c≤0.5, and 0.001≤d≤0.1), LiₐNi_{b}Co_{c}Mn_{d}GₑO₂ (wherein 0.90≤a≤1.8, 0≤5≤0.9, 0≤s≤0.5, 0≤d≤0.5, and 0.001≤b≤0.1), LiₐNiG_{b}O₂(wherein 0.90≤a≤1.8 and 0.001≤b≤0.1), LiₐCoG_{b}O₂ (wherein 0.90≤a≤1.8 and 0.001≤b≤0.1), LiₐMnG_{b}O₂ (wherein 0.90≤a≤1.8 and 0.001≤b≤0.1), LiₐMn₂G_{b}O₄ (wherein 0.90≤a≤1.8 and 0.001≤b≤0.1), QO₂, QS₂, LiQS₂, V₂O₅, LiV₂O₂, Lil′O₂, LiNiVO₄, Li_{(3-f)}J₂(PO₄)₃ (wherein 0≤f≤2), Li_{(3-f)}Fe₂(PO₄)₃ (wherein 0≤f≤2), or LiFePO₄ may be used. In the above formulas, A is Ni, Co, Mn, or a combination thereof, B′ is Al, Ni, Co, Mn, Cr, Fe, Mg, Sr, V, a rare earth element, or a combination thereof, D′ is O, F, S, P, or a combination thereof, E is Co, Mn, or a combination thereof, F′ is F, S, P, or a combination thereof, G is Al, Cr, Mn, Fe, Mg, La, Ce, Sr, V, or a combination thereof, Q is Ti, Mo, Mn, or a combination thereof, I′ is Cr, V, Fe, Sc, Y, or a combination thereof, and J is V, Cr, Mn, Co, Ni, Cu, or a combination thereof. For example, the positive electrode active material may include one or more of lithium cobalt oxide, lithium nickel oxide, lithium nickel cobalt oxide, lithium nickel cobalt aluminum oxide, lithium nickel cobalt manganese oxide, lithium manganese oxide, lithium iron phosphate oxide, nickel sulfide, copper sulfide, lithium sulfide, iron oxide or vanadium oxide. For example, the positive electrode active material may be LiCoO₂, LiMnₓO₂ₓ (wherein x=1, 2), LiNi₁₋ₓMnₓO₂ₓ (wherein 0<x<1), LiNi_{1-x-y}CoₓMn_{y}O₂ (wherein 0≤x≤0.5 and 0≤y≤0.5), LiFePO₄, TiS₂, FeS₂, TiS₃, or FeS₃.

The positive electrode active material layer 12 may further include an ionic liquid electrolyte. The ionic liquid electrolyte may be non-volatile. Ionic liquids refer to salts in a liquid state at room temperature or molten salts at room temperature which have a melting point equal to or less than room temperature and are composed of ions only. The ionic liquids may be one selected from compounds including a) one or more cations of ammonium, pyrrolidinium-, pyridinium, pyrimidinium, imidazolium, piperidinium, pyrazolium, oxazolium, pyridazinium, phosphonium, sulfonium, and triazolium cations or mixtures thereof, and b) one or more anions of BF₄_{^{−}}, PF₆_{^{−}}, AsF₆_{^{−}}, SbF₆_{^{−}}, AlCl₄_{^{−}}, HSO₄_{^{−}}, ClO₄_{^{−}}, CH₃SO₃_{^{−}}, CF₃CO₂_{^{−}}, Cl⁻, Br⁻, I⁻, SO₄_{^{−}}, CF₃SO₃_{^{−}}, (FSO₂)₂N⁻, (C₂F₅SO₂)₂N⁻, (C₂F₅SO₂)(CF₃SO₂)N⁻, or (CF₃SO₂)₂N. For example, the ionic liquids may be one or more of N-methyl-N-propylpyrrolidinium bis(trifluoromethanesulfonyl)imide N-butyl-N-methylpyrrolidium bis(3-trifluoromethylsulfonyl)imide, 1-butyl-3-methylimidazolium bis(trifluoromethylsulfonyl)amide, or 1-ethyl-3-methylimidazolium bis(trifluoromethylsulfonyl)amide. Polymer ionic liquids may include a repeating unit including a) one or more cations of ammonium, pyrrolidinium, pyridinium, pyrimidinium, imidazolium, piperidinium, pyrazolium, oxazolium, pyridazinium, phosphonium, sulfonium, or triazolium cations, and b) one or more anions of BF₄_{^{−}}, PF₆_{^{−}}, AsF₆_{^{−}}, SbF₆_{^{−}}, AlCl₄_{^{−}}, HSO₄_{^{−}}, ClO₄_{^{−}}, CH₃SO₃_{^{−}}, CF₃CO₂_{^{−}}, (CF₃SO₂)₂N⁻, (FSO₂)N⁻, Cl⁻, Br⁻, I⁻, SO₄_{^{−}}, CF₃SO₃, (C₂F₅SO₂)₂N⁻, (C₂F₅SO₂)(CF₃SO₂)N⁻, NO₃_{^{−}}, Al₂Cl₇_{^{−}}, (CF₃SO₂)₃C⁻, (CF₃)₂PF₄_{^{−}}, (CF₃)₃PF₃_{^{−}}, (CF₃)₄PF₂_{^{−}}, (CF₃)₅PF⁻, (CF₃)₆P⁻, SF₅CF₂SO₃_{^{−}}, SF₅CHFCF₂SO₃_{^{−}}, CF₃CF₂(CF₃)₂CO⁻, (CF₃SO₂)₂CH⁻, (SF₅)₃C⁻, or (O(CF₃)₂C₂(CF₃)₂O)₂PO⁻.

The ionic liquid electrolyte may be filled in the pores of the surface of the solid electrolyte layer 30 in contact with the positive electrode active material layer 12. The amount of the ionic liquid electrolyte may be about 0.1 to about 20 parts by weight, about 0.1 to about 15 parts by weight, about 0.1 to about 10 parts by weight, or about 0.1 to about 5 parts by weight, based on 100 parts by weight of the positive electrode active material layer 12 not including the ionic liquid electrolyte. By including an ionic liquid electrolyte to improve ion conductivity, charge/discharge characteristics of an all-solid secondary battery 1, 1 a may be improved.

The positive electrode active material layer 12 may further include a conductive material and a binder. The conductive material may include carbon black, carbon tubes, carbon fibers, graphite, or a combination thereof, for example. For example, the carbon black may be acetylene black, KETJEN black, SUPER P carbon, channel black, furnace black, lamp black, thermal black, or a combination thereof. The graphite may be natural graphite or artificial graphite. A combination including at least one of the foregoing may be used. For example, the conductive material may be in the form of particles. The positive electrode active material layer 12 may include an additional conductive material of a different composition in addition to the conductive material. The additional conductive material may be electrically conductive fibers such as metal fibers; carbon fluoride powder; metal powder such as aluminum powder or nickel powder; conductive whiskers such as zinc oxide or potassium titanate; polyethylene derivatives; or a combination thereof. The amount of the conductive material may be in the range from about 1 to about 10 parts by weight, for example, from about 2 to about 7 parts by weight, based on 100 parts by weight of the positive electrode active material. When the amount of the conductive material is in this range, for example, in the range of about 1 part by weight to about 10 parts by weight, the electrical conductivity of the positive layer 10 may be satisfactory.

The binder may improve the adhesion between the components of the positive electrode layer 10 and the adhesion to the positive electrode current collector 11. Examples of the binder include polyacrylic acid (PAA), polyvinylidene fluoride, polyvinyl alcohol, carboxymethyl cellulose (CMC), starch, hydroxypropyl cellulose, regenerated cellulose, polyvinylpyrrolidone, tetrafluoroethylene, polyethylene, polypropylene, ethylene-propylene-diene monomer (EPDM), sulfonated EPDM, styrene-butadiene-rubber, fluorinated rubber, copolymers thereof, or a combination thereof. The amount of the binder may be in the range of about 1 to about 10 parts by weight, for example, in the range of about 2 to about 7 parts by weight, based on 100 parts by weight of the positive electrode active material. When the amount of the binder is in this range, the adhesion of the positive electrode active material layer 12 to the positive electrode current collector 11 may be further improved, and a decrease in the energy density of the positive electrode active material layer 12 may be suppressed.

N-methylpyrrolidone, acetone, water and the like may be used as a solvent. The amount of the positive electrode active material, the conductive material, the binder, and the solvent are quantities commonly used in all-solid secondary batteries.

The composition for the positive electrode active material layer 12 may be prepared by appropriately mixing additives such as a filler, a dispersant, and an ion-conductive auxiliary agent, in addition to the positive electrode active material, the solid electrolyte, the conductive material, and the binder. If necessary, a plasticizer may be added to the composition to form pores inside the positive electrode active material layer 12. As a filler, a dispersant, an ion-conductive auxiliary agent, a plasticizer, and the like, a known material generally used in the electrodes of all-solid secondary batteries 1 and 1 a may be used.

The negative electrode layer 20 may include a negative electrode current collector 21 and a negative electrode active material layer 22.

Examples of the material constituting the negative electrode current collector 21 include copper (Cu), stainless steel, titanium (Ti), iron (Fe), cobalt (Co), and nickel (Ni). The negative electrode current collector 21 may be composed of one metal, or may be composed of an alloy or coating material of two or more metals. The negative electrode current collector 21 may be formed, for example, in a plate shape or a foil shape.

The negative electrode active material layer 22 may include lithium metal or a lithium alloy. Examples of the lithium alloy are alloys including lithium and one or more selected from gold, platinum, palladium, silver, aluminum, bismuth, tin, or zinc. If necessary, the negative electrode active material layer 22 may include a carbonaceous negative electrode active material and a combination of the carbonaceous negative electrode active material with lithium metal or lithium alloy.

Examples of the carbonaceous negative electrode active material include graphite, carbon black (CB), acetylene black (AB), furnace black (FB), KETJEN black (KB), graphene (graphene), carbon nanotubes, or carbon nanofibers.

The negative electrode active material layer 22 may be formed by appropriately mixing additives such as a conductive material, a binder, a filler, a dispersant, and an ion-conductive auxiliary agent, formed of the same materials as mentioned in the positive electrode layer 10.

If necessary, the negative electrode active material layer 22 may be an anodeless coating layer. For example, the anodeless coating layer may include carbon and a metalloid such as silicon, and may have a structure in which a conductive binder is disposed around the metalloid and carbon. The thickness of the anodeless coating layer may be about 1 micrometer (pm) to about 20 μm.

The solid electrolyte layer 30 may include the solid electrolyte.

The solid electrolyte layer 30 may further include an oxide solid electrolyte, a sulfide solid electrolyte, a polymer solid electrolyte, or a combination thereof.

The solid electrolyte layer 30 may be a single layer or a plurality of layers. For example, the solid electrolyte layer 30 may be a two-layer solid electrolyte layer having a first solid electrolyte layer at a position facing the positive electrode layer 10 and a second solid electrolyte layer on the first solid electrolyte layer. The first solid electrolyte layer may be the aforesaid mixed solid ion conductor, and the second solid electrolyte layer may be an oxide solid electrolyte, a sulfide solid electrolyte, a polymer solid electrolyte, or a combination thereof. Conversely, the first solid electrolyte layer may be an oxide solid electrolyte, a sulfide solid electrolyte, a polymer solid electrolyte, or a combination thereof, and the second solid electrolyte layer may be the mixed solid ion conductor.

Examples of the oxide-based solid electrolyte include one or more selected from Li_{1+x+y}AlₓTi₂₋ₓSi_{y}P_{3-y}O₁₂ (wherein 0<x<2 and 0≤y<3), BaTiO₃, Pb(ZrₐTi₁₋ₐ)O₃ (PZT) (wherein 0≤a≤1), Pb₁₋ₓLaₓZr_{1-y}Ti_{y}O₃ (PLZT) (wherein 0≤x<1 and 0≤y<1), PB(Mg₃Nb_{2/3})O₃_{^{−}}PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, Li₃PO₄, LiₓTi_{y}(PO₄)₃ (wherein 0<x<2 and 0<y<3), LiₓAl_{y}Ti_{z}(PO₄)₃ (wherein 0<x<2, 0<y<1, and 0<z<3), Li_{1+x+y}(AlₐGa₁₋ₐ)x(Ti_{b}Ge_{1-b})₂₋ₓSi_{y}P_{3-y}O₁₂ (wherein O≤x≤1, 0≤y≤1, 0≤a≤1, and 0≤b≤1), LiₓLa_{y}TiO₃ (wherein 0<x<2 and 0<y<3), Li₂O, LiOH, Li₂CO₃, LiAlO₂, Li₂O—Al₂O₃—SiO₂—P₂O₅ —TiO₂-GₑO₂, and Li₃₊ₓLa₃M₂O₁₂ (wherein M═Te, Nb or Zr and x is an integer of 1 to 10).

The oxide solid electrolyte may be prepared by a sintering method, a casting method, or the like.

For example, the oxide solid electrolyte may be a garnet-type solid electrolyte.

For example, the garnet-type solid electrolyte may include an oxide represented by the following Formula 1.

(LiₓM′1_{y})(M′2)_{3-δ}(M′3)_{2-ω}O_{12-z}X′z. Formula 1

In Formula 1, 6≤x≤8, 0≤y<2, −0.25≤≈≤0.2, −0.2≤ω≤0.2, and 0≤z≤2,
M′1 is a monovalent cation, a divalent cation, a trivalent cation, or a combination thereof,
M′2 is a monovalent cation, a divalent cation, a trivalent cation, or a combination thereof,
M′3 is a monovalent cation, divalent cation, trivalent cation, tetravalent cation, pentavalent cation, hexavalent cation, or a combination thereof, and
X′ is a monovalent anion, a divalent anion, a trivalent anion, or a combination thereof.

In Formula 1, examples of the monovalent cation include Na, K, Rb, Cs, H, and Fr, and examples of the divalent cation include Mg, Ca, Ba, and Sr. Examples of the trivalent cation include In, Sc, Cr, Au, B, Al, and Ga, and examples of the tetravalent cation include Sn, Ti, Mn, Ir, Ru, Pd, Mo, Hf, Ge, V, and Si. Examples of the pentavalent cation include Nb, Ta, Sb, V, and P.

M′1 is, for example, hydrogen (H), iron (Fe), gallium (Ga), aluminum (Al), boron (B), beryllium (Be), or a combination thereof. M′2 is La (lanthanum), barium (Ba), calcium (Ca), strontium (Sr), yttrium (Y), bismuth (Bi), praseodymium (Pr), neodymium (Nd), actinium (Ac), samarium (Sm), gadolinium (Gd), or a combination thereof. M′3 is zirconium (Zr), hafnium (Hf), tin (Sn), niobium (Nb), titanium (Ti), vanadium (V), chromium (Cr), manganese (Mn), cobalt (Co), nickel (Ni), copper (Cu), molybdenum (Mo), tungsten (W), tantalum (Ta), magnesium (Mg), technetium (Tc), ruthenium (Ru), palladium (Pd), iridium (Ir), scandium (Sc), cadmium (Cd), indium (In), antimony (Sb), tellurium (Te), thallium (TI), platinum (Pt), silicon (Si), aluminum (Al), or a combination thereof.

In Formula 1, the monovalent anion used as X′ is a halogen atom, a pseudohalogen, or a combination thereof, the divalent anion used as X′ is S²⁻ or Se²⁻, and the trivalent anion used as X′ is, for example, N³⁻.

In Formula 1, 6.6≤x≤8, 6.7≤x≤7.5, or 6.8≤x≤7.1.

For example, the garnet-type solid electrolyte may include an oxide represented by the following Formula 2.

LiₓM′1_{y})(Laₐ₁M′2ₐ₂)_{3-δ}(Zr_{b1}M′3_{b2})_{2-ω}O_{12-z}X′z. Formula 2

In Formula 2, M′1 is hydrogen (H), iron (Fe), gallium (Ga), aluminum (Al), boron (B), beryllium (Be), or a combination thereof,
M′2 is barium (Ba), calcium (Ca), strontium (Sr), yttrium (Y), bismuth (Bi), praseodymium (Pr), neodymium (Nd), actinium (Ac), samarium (Sm), gadolinium (Gd), or a combination thereof.
M′3 is hafnium (Hf), tin (Sn), niobium (Nb), titanium (Ti), vanadium (V), chromium (Cr), manganese (Mn), cobalt (Co), nickel (Ni), copper (Cu), molybdenum (Mo), tungsten (W), tantalum (Ta), magnesium (Mg), technetium (Tc), ruthenium (Ru), palladium (Pd), iridium (Ir), scandium (Sc), cadmium (Cd), indium (In), antimony (Sb), tellurium (Te), thallium (TI), platinum (Pt), silicon (Si), aluminum (Al), or a combination thereof,

In Formula 2, 6≤x≤8, 0≤y<2, −0.2≤δ≤0.2, −0.2≤ω≤0.2, 0≤≤2,

a1+a2=1,0<a1≤1,0≤a2<1,

b1+b2=1,0<b1≤1,0≤b2<1, and
X′ is a monovalent anion, a divalent anion, a trivalent anion, or a combination thereof.

In Formula 2, the monovalent anion used as X′ is a halogen atom, a pseudohalogen, or a combination thereof, the divalent anion used as X′ is S²⁻ or Se²⁻, and the trivalent anion used as X′ is, for example, N³⁻.

In Formula 2, 6.6≤x≤8, 6.7≤x≤7.5, or 6.8≤x≤7.1.

In this disclosure, a “pseudohalogen” is a molecule composed of two or more electronegative atoms similar to halogens in the free state, and generates anions similar to halide ions. Examples of pseudohalogen include cyanide, cyanate, thiocyanate, azide, or a combination thereof.

The halogen atom is, for example, iodine (I), chlorine (Cl), bromine (Br), fluorine (F), or a combination thereof, and the pseudohalogen is, for example, cyanide, cyanate, thiocyanate, azide, or a combination thereof.

The trivalent anion is, for example, N³.

In Formula 2, M′3 is Al, Ga, In, Si, Ge, Sn, Sb, Bi, Sc, Y, Ti, Hf, V, Nb, Ta, W, or a combination thereof.

According to another embodiment, the garnet-type solid electrolyte may be an oxide represented by the following Formula 3.

Li₃₊ₓLa₃Zr₂₋ₐ(M′4)ₐO₁₂. Formula 3

In Formula 3, M′4 is Al, Ga, In, Si, Ge, Sn, Sb, Bi, Sc, Y, Ti, Hf, V, Nb, Ta, W, or a combination thereof, x is a number of 1 to 10, and 0≤a<2.

Examples of the garnet-type solid electrolyte include Li₇La₃Zr₂O₁₂ and Li_{6.5}La₃Zr_{1.5}Ta_{0.5}O₁₂.

The garnet-type solid electrolyte has an ion conductivity of 1 (millisiemens per centimeter, mS·cm⁻¹) or more, and may be manufactured in the form of pellets, tapes, and films. The garnet-type solid electrolyte may be manufactured to have various thicknesses over a wide temperature range.

The sulfide solid electrolyte is not particularly limited as long as it includes sulfur (S) or sulfur-group elements (Se, Te) and has ion conductivity. For example, the sulfide-based solid electrolyte include one or more selected from Li₂S—P₂S₅, Li₂S—P₂S₅—LiX (X is a halogen element), Li₂S—P₂S₅—Li₂O, Li₂S—P₂S₅—Li₂O-Lil, Li₂S—SiS₂, Li₂S—SiS₂-Lil, Li₂S —SiS₂—LiBr, Li₂S—SiS₂—LiCl, Li₂S—SiS₂—B₂S₃-Lil, Li₂S—SiS₂—P₂S₅-Lil, Li₂S—B₂S₃, Li₂S—P₂S₅—ZₘSₙ (m, n are positive numbers, Z is Ge, Zn or Ga), Li₂S—GeS₂, Li₂S—SiS₂—Li₃PO₄, and Li₂S—SiS₂-LiₚMO_{q} (p, q are positive numbers, M is one of P, Si, Ge, B, Al, Ga and In). When using material including Li₂S—P₂S₅ as sulfide solid electrolyte, the mixing molar ratio of Li₂S and P₂S₅ may be about 50:50 to about 90:10, or about 60:40 to about 90:10, or about 75:25 to about 90:10. The sulfide solid electrolyte may be prepared by a treating a raw starting material (for example, Li₂S, P₂S₅) by a melt quenching method, a mechanical milling method, or the like. Additionally, calcinations may be performed after the treatment.

The sulfide solid electrolyte may include a compound represented by the following Formula 4.

LiₐM′5ₓPS_{y}M′6_{z}M′7_{w}. Formula 4

In Formula 4, M′5 is one or more metal elements other than Li and selected from Groups 1 to 15 of the Periodic Table of the Elements, and M′6 is one or more elements selected from Group 17 of the Periodic Table of the Elements,
M′7 is SOₙ, 4≤a≤8, 0≤x<1, 3≤y≤7, 0<z≤5, 0≤w<2, and 1.5≤n≤5.

In Formula 4, 0<z≤5, 0<z≤4, 0<z≤3, 0<z≤2, 0.2≤z≤1.8, 0.5≤z≤1.8, 1.0≤z≤1.8 or 1.0≤z≤1.5.

In Formula 4, 5≤a≤8, 0≤x≤0.7, 4≤y≤7, 0<z≤2 and 0≤w≤0.5, for example, 5≤a≤7, 0≤x≤0.5, 4≤y≤6, 0<z≤2 and 0≤w≤0.2, for example, 5.5≤a≤7, 0≤x≤0.3, 4.5≤y≤6, 0.2≤z≤1.8 and 0<w<0.1, for example, 5.5≤a≤6, 0≤x≤0.05, 4.5≤y≤5, 1.0≤z≤1.5 and 0≤w≤0.1.

For example, in the compound represented by Formula 4, M′5 is Na, K, Mg, Ag, Cu, Hf, In, Ti, Pb, Sb, Fe, Zr, Zn, Cr, B, Sn, Ge, Si, Zr, Ta, Nb, V, Ga, Al, As, or a combination thereof. M′5 may be, for example, a monovalent cation or a divalent cation.

For example, in the compound represented by Formula 4, M′6 may include F, Cl, Br, I, or a combination thereof. M′6 may be, for example, a monovalent anion.

In the compound represented by Formula 4, for example, SOₙ of M′7 may be S₄O₆, S₃O₆, S₂O₃, S₂O₄, S₂O₅, S₂O₆, S₂O₇, S₂O₈, SO₄, SO₅, or a combination thereof. SOₙ may be, for example, a divalent anion. SOₙ²⁻ may be, for example, S₄O₆²⁻, S₃O₆²⁻, S₂O₃²⁻, S₂O₄²⁻, S₂O₅²⁻, S₂O₆²⁻, S₂O₇²⁻, S₂O₈²⁻, SO₄²⁻, SO₅²⁻, or a combination thereof.

For example, the compound represented by Formula 4 may be a compound selected from compounds represented by Formulas 4a to 4b below.

LiₐPS_{y}M″7_{z}M′8_{w}. Formula 4A

In Formula 4a, M″7 is one or more element selected from Group 17 of the Periodic Table of the Elements, M′8 is SOₙ, 4≤a≤8, 3≤y≤7, 0<z≤5, 0<w<2, and 1.5≤n≤5.

LiₐM′9ₓPS_{y}M′10_{z}M′11_{w}. Formula 4B

In Formula 4b, M′9 is one or more metal elements other than Li and selected from Groups 1 to 15 of the Periodic Table of the Elements, and M′10 is one or more elements selected from Group 17 of the Periodic Table of the Elements,
M′11 is SOₙ, 4≤a≤8, 0<x<1, 3≤y≤7, 0<z≤5, 0<w<2, and 1.5≤n≤5.

In Formulas 4A and 4B, 0<z≤5, 0<z≤4, 0<z≤3, 0<z≤2, 0.2≤z≤1.8, 0.5≤z≤1.8, 1.0≤z≤1.8 or 1.0≤z≤1. In Formulas 4A and 4B, for example, 5≤a≤8, 4≤y≤7, 0<z≤2 and 0≤w≤0.5; 5.5≤a≤7, 4.5≤y≤6, 0.2≤z≤1.8, and 0≤w≤0.1; 0.5≤z≤1.8; or 1.0≤z≤1.8.

For example, the compound represented by Formula 4 may be a compound represented by Formula 5 below.

Li_{7-m×v-z}M′12ᵥPS_{6-z}M′13_{z1}M′14_{z2}. Formula 5

In Formula 5, M′12 is Na, K, Mg, Ag, Cu, Hf, In, Ti, Pb, Sb, Fe, Zr, Zn, Cr, B, Sₙ, Ge, Si, Zr, Ta, Nb, V, Ga, Al, As, or a combination thereof, m is the oxidation number of M′12, and M′13 and M′14 are each independently F, Cl, Br, or I, and 0<v<0.7, 0<z1<2, 0≤z2<1, 0<z<2, z=z1+z2 and 1≤m≤2.

For example, 0<v<0.7, 0<z1<2, 0≤z2<1, 0<z<2, z=z1+z2 and 1≤m≤2. For example, 0<v≤0.5, 0<z1<2, 0≤z2≤0.5, 0<z<2 and z=z1+z2. For example, 0<v≤0.3, 0<z1≤1.5, 0≤z2≤0.5, 0.2≤z≤1.8 and z=z1+z2. For example, 0<v≤0.1, 0<z1≤1.5, 0≤z2≤0.5, 0.5≤z≤1.8 and z=z1+z2. For example, 0<v≤0.05, 0<z1≤1.5, 0≤z2≤0.2, 1.0≤z≤1.8 and z=z1+z2. M′12 may be, for example, one metal element or two metal elements.

For example, the compound represented by Formula 5 contains one halogen element or two halogen elements.

For example, the compound represented by Formula 5 is a solid ion conductor compound represented by one of the following Formulas 5a to 5f.

Li_{7-z}PS_{6-z}M′15_{z1}M′16_{z2} Formula 5A

Li_{7-v-z}NaᵥPS_{6-z}M′15_{z1}M′16_{z2} Formula 5B

Li_{7-v-z}KᵥPS_{6-z}M′15_{z1}M′16_{z2} Formula 5C

Li_{7-v-z}CuᵥPS_{6-z}M′15_{z1}M′16_{z2} Formula 5D

Li_{7-v-z}MgᵥPS_{6-z}M′15_{z1}M′16_{z2} Formula 5E

Li_{7-v-z}AgᵥPS_{6-z}M′15_{z1}M′16_{z2} Formula 5F

In the above formulas, M′15 and M′16 are each independently F, Cl, Br, or I, 0<v≤0.05, 0<z1≤1.5, 0≤z2≤0.2, 1.0≤z≤1.8 and z=z1+z2.

In Formulas 5A to 5F, independently of each other, for example, 0<v≤0.7, 0<z1<2, 0≤z2≤0.5, 0<z<2, and z=z1+z2; 0<vs0.5, 0<z1<2, 0≤z2≤0.5, 0<z<2 and z=z1+z2; 0<v≤0.3, 0<z1≤1.5, 0≤z2≤0.5, 0.2≤z≤1.8 and z=z1+z2; 0<v≤0.05, 0<z≤1.5, 0≤z2≤0.2, 1.0≤z≤1.8 and z=z1+z2; for example, 0<v≤0.05, 0<z1≤1.5, 0≤z2≤0.2, 1.0≤z≤1.5 and z=z1+z2. In Formula 5B, v=0.

The compound represented by Formula 4 may be, for example, a compound represented by one of the following formulas:
Li_{7-z}PS_{6-z}F_{z1}, Li_{7-z}PS_{6-z}Cl_{z1}, Li_{7-z}PS_{6-z}Br_{z1}, Li_{7-z}PS_{6-z}I_{z1}, Li_{7-z}PS_{6-z}F_{z1}Cl_{z2}, Li_{7-z}PS_{6-z}F_{z1}Br_{z2}, Li_{7-z}PS_{6-z}F_{z1}I_{z2}, Li_{7-z}PS_{6-z}Cl_{z1} Br_{z2}, Li_{7-z}PS_{6-z}Cl_{z1}I_{z2}, Li_{7-z}PS_{6-z}Cl_{z1} F_{z2}, Li_{7-z}PS_{6-z}Br_{z1}I_{z2}, Li_{7-z}PS_{6-z}Br_{z1} F_{z2}, Li_{7-z}PS_{6-z}Br_{z1}Cl_{z2}, Li_{7-z}PS_{6-z}I_{z1}F_{z2}, Li_{7-z}PS_{6-z}I_{z1}Cl_{z2}, Li_{7-z}PS_{6-z} I_{z1}Br_{z2}, Li_{7-v-z}NaᵥPS_{6-z}F_{z1}, Li_{7-v-z}NaᵥPS_{6-z}Cl_{z1}, Li_{7-v-z}NaᵥPS_{6-z}Br_{z1}, Li_{7-v-z}NaᵥPS_{6-z}I_{z1}, Li_{7-v- z}NaᵥPS_{6-z}F_{z1}Cl_{z2}, Li_{7-v-z}NaᵥPS_{6-z}F_{z1}Br_{z2}, Li_{7-v-z}NaᵥPS_{6-z}F_{z1}I_{z2}, Li_{7-v-z}NaᵥPS_{6-z}Cl_{z1}Br_{z2}, Li_{7-v-z}NaᵥPS_{6-z}Cl_{z1}I_{z2}, Li_{7-v-z}NaᵥPS_{6-z}Cl_{z1}F_{z2}, Li_{7-v-z}NaᵥPS_{6-z}Br_{z1}I_{z2}, Li_{7-v-z}NaᵥPS_{6-z}Br_{z1}F_{z2}, Li_{7-v-z}NaᵥPS_{6-z}Br_{z1}Cl_{z2}, Li_{7-v-z}NaᵥPS_{6-z}I_{z1}F_{z2}, Li_{7-v-z}NaᵥPS_{6-z}I_{z1}Cl_{z2}, Li_{7-v-z}NaᵥPS_{6-z}I_{z1}Br_{z2}, Li_{7-v-z}KᵥPS_{6-z}F_{z1}, Li_{7-v-z}KᵥPS_{6-z}Cl_{z1}, Li_{7-v-z}KᵥPS_{6-z}Br_{z1}, Li_{7-v-z}KᵥPS_{6-z}I_{z1},
Li_{7-v-z}KᵥPS_{6-z}F_{z1}Cl_{z2}, Li_{7-v-z}KᵥPS_{6-z}F_{z1}Br_{z2}, Li_{7-v-z}KᵥPS_{6-z}F₂₁I_{z2}, Li_{7-v-z}KᵥPS_{6-z}Cl_{z1}Br_{z2}, Li_{7-v-z}KᵥPS_{6-z}Cl_{z1}I_{z2}, Li_{7-v-z}KᵥPS_{6-z}Cl_{z1}F_{z2}, Li_{7-v-z}KᵥPS_{6-z}Br_{z1}I_{z2}, Li_{7-v-z}KᵥPS_{6-z}Br_{z1}F_{z2}, Li_{7-v-z}KᵥPS_{6-z}Br_{z1}Cl_{z2}, Li_{7-v-z}KᵥPS_{6-z}I_{z1}F_{z2}, Li_{7-v-z}KᵥPS_{6-z}I_{z1}Cl_{z2}, Li_{7-v-z}KᵥPS_{6-z}I_{z1}Br_{z2},
Li_{7-v-z}CuᵥPS_{6-z}F_{z1}, Li_{7-v-z}CUᵥPS_{6-z}Cl_{z1}, Li_{7-v-z}CuᵥPS_{6-z}Br_{z1}, Li_{7-v-z}CuᵥPS_{6-z}I_{z1}, Li_{7-v-z}CuᵥPS_{6-z}F_{z1}Cl_{z2}, Li_{7-v-z}CUᵥPS_{6-z}F_{z1}Br_{z2}, Li_{7-v-z}CUᵥPS_{6-z}F_{z1}I_{z2}, Li_{7-v-z}CuᵥPS_{6-z}Cl_{z1}Br_{z2}, Li_{7-v-z}CuᵥPS_{6-z}Cl_{z1}I_{z2}, Li_{7-v-z}CuᵥPS_{6-z}Cl_{z1}F_{z2}, Li_{7-v-z}CuᵥPS_{6-z}Br_{z1}I_{z2}, Li_{7-v-z}CuᵥPS_{6-z}Br_{z1}F_{z2}, Li_{7-v-z}CuᵥPS_{6-z}Br_{z1}Cl_{z2}, Li_{7-v-z}CuᵥPS_{6-z}I_{z1}F_{z2}, Li_{7-v-z}CuᵥPS_{6-z}I_{z1}Cl_{z2}, Li_{7-v-z}CuᵥPS_{6-z}I_{z1}Br_{z2},
Li_{7-v-z}MgᵥPS_{6-z}F_{z1}, Li_{7-v-z}MgᵥPS_{6-z}Cl_{z1}, Li_{7-v-z}MgᵥPS_{6-z}Br_{z1}, Li_{7-v-z}MgᵥPS_{6-z}I_{z1},
Li_{7-v-z}MgᵥPS_{6-z}F_{z1}Cl_{z2}, Li_{7-v-z}MgᵥPS_{6-z}F_{z1}Br_{z2}, Li_{7-v-z}MgᵥPS_{6-z}F_{z1}I_{z2}, Li_{7-v-z}MgᵥPS_{6-z}Cl_{z1}Br_{z2}, Li_{7-v-z}MgᵥPS_{6-z}Cl_{z1}I_{z2}, Li_{7-v-z}MgᵥPS_{6-z}Cl_{z1}F_{z2}, Li_{7-v-z}MgᵥPS_{6-z}Br_{z1}I_{z2}, Li_{7-v-z}MgᵥPS_{6-z}Br_{z1}F_{z2}, Li_{7-v-z}MgᵥPS_{6-z}Br_{z1}Cl_{z2}, Li_{7-v-z}MgᵥPS_{6-z}I_{z1}F_{z2}, Li_{7-v-z}MgᵥPS_{6-z}I_{z1}Cl_{z2}, Li_{7-v-z}MgᵥPS_{6-z}I_{z1}Br_{z2},
Li_{7-v-z}AgᵥPS_{6-z}F_{z1}, Li_{7-v-z}AgᵥPS_{6-z}Cl_{z1}, Li_{7-v-z}AgᵥPS_{6-z}Br_{z1}, Li_{7-v-z}AgᵥPS_{6-z}I_{z1}, Li_{7-v-z}AgᵥPS_{6-z}F_{z1}Cl_{z2}, Li_{7-v-z}AgᵥPS_{6-z}F_{z1}Br_{z2}, Li_{7-v-z}AgᵥPS_{6-z}F_{z1}I_{z2}, Li_{7-v-z}AgᵥPS_{6-z}Cl_{z1}Br_{z2}, Li_{7-v-z}AgᵥPS_{6-z}Cl_{z1}I_{z2}, Li_{7-v-z}AgᵥPS_{6-z}Cl_{z1}F_{z2}, Li_{7-v-z}AgᵥPS_{6-z}Br_{z1}I_{z2}, Li_{7-v-z}AgᵥPS_{6-z}Br_{z1}F_{z2}, Li_{7-v-z}AgᵥPS_{6-z}Br_{z1}Cl_{z2}, Li_{7-v-z}AgᵥPS_{6-z}I_{z1}F_{z2}, Li_{7-v-z}AgᵥPS_{6-z}I_{z1}Cl_{z2}, and Li_{7-v-z}AgᵥPS_{6-z}I_{z1}Br_{z2},
wherein in the above Formulas, independently of each other, 0<v<0.7, 0<z1<2, 0<z2<1, 0<z<2 and z=z1+z2; for example, 0<v≤0.7, 0<z1<2, 0<z2≤0.5, 0<z<2 and Z=z1+z2; 0<v≤0.3, 0<z1≤1.5, 0<z2≤0.5, 0.2≤z≤1.8 and z=z1+z2; 0<v≤0.05, 0<z1≤1.5, 0<z2≤0.2, 1.0≤z≤1.8 and z=z1+z2; or 0<v≤0.05, 0<z1≤1.5, 0<z2≤0.2, 1.0≤z≤1.5 and Z=z1+z2. In the above Formulas, if there is no v, z1 or z2, v=0, z1=0, or z2=0. For example, if z1=0, then z=z2. For example, if z2=0, then z=z1.

The compound represented by Formula 4 may, for example, belong to a cubic crystal system and, more specifically, to an F-43m space group. Additionally, as described above, the compound represented by Formula 4 may be an argyrodite-type sulfide having an argyrodite-type crystal structure. The compound represented by Formula 4 may have further improved lithium ion conductivity and electrochemical stability with respect to lithium metal, by including, for example, one or more of a monovalent cationic element and a divalent cationic element substituted into a portion of the lithium sites in the argyrodite-type crystal structure, or including a heterogeneous halogen element, or including a substituted SOₙ anion in the halogen site.

The compound represented by Formula 4 is, for example, Li₆PS₅Cl.

In this disclosure, the sulfide solid electrolyte may be an argyrodite-type compound including one or more of Li₇₋ₓPS₆₋ₓClₓ (0≤x≤2), Li₇₋ₓPS₆₋ₓBrₓ (0≤x≤2), or Li₇₋ₓPS₆₋ₓIₓ (0≤x≤2). In particular, the sulfide solid electrolyte included in the solid electrolyte may be an argyrodite-type compound including one or more of Li₆PS₅Cl, Li₆PS₅Br, or Li₆PS₅I.

Examples of polymer solid electrolyte include polyethylene oxide, polypropylene oxide, polystyrene (PS), polyphosphogene, polysiloxane, polyvinylidene fluoride-co-hexafluoropropylene (PVDF-HFP), polyacrylonitrile (PAN), and combinations thereof. The ion conductivity of this polymer solid electrolyte may be achieved by local segmental motion of the polymer. The polymer solid electrolytes may be prepared by mixing polyether with plasticizer salts, and sometimes with some liquid plasticizer. Such electrolytes may be prepared into thin films by a solvent evaporation coating method. However, the electrolyte is not limited thereto, and any polymer solid electrolyte available in the art may be used.

If necessary, the solid electrolyte may further include a binder. The binder included in the solid electrolyte layer 30 is, for example, styrene-butadiene rubber (SBR), polytetrafluoroethylene, polyvinylidene fluoride, or polyethylene, but is not limited thereto, and anything that may be used as a binder in the art is available.

The solid electrolyte layer 30 may be prepared by deposition with a known film formation method such as an aerosol deposition method, a cold spray method, or a sputtering method. Alternatively, the solid electrolyte layer 30 may be prepared by pressing single particles of the solid electrolyte. Alternatively, the solid electrolyte layer 30 may be prepared by mixing a solid electrolyte, a solvent, and a binder, applying the mixture, drying, and pressing.

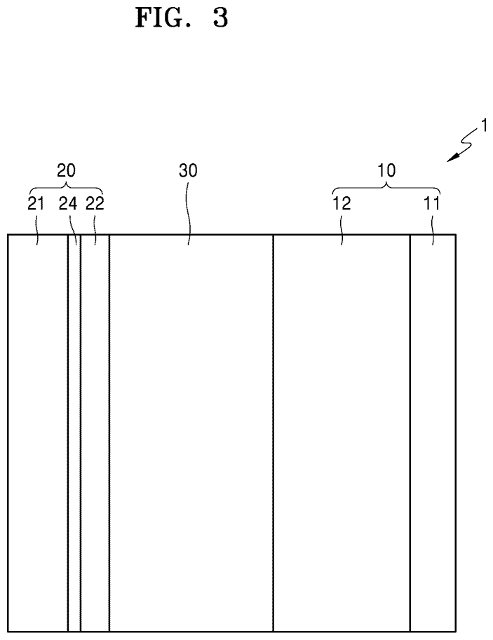

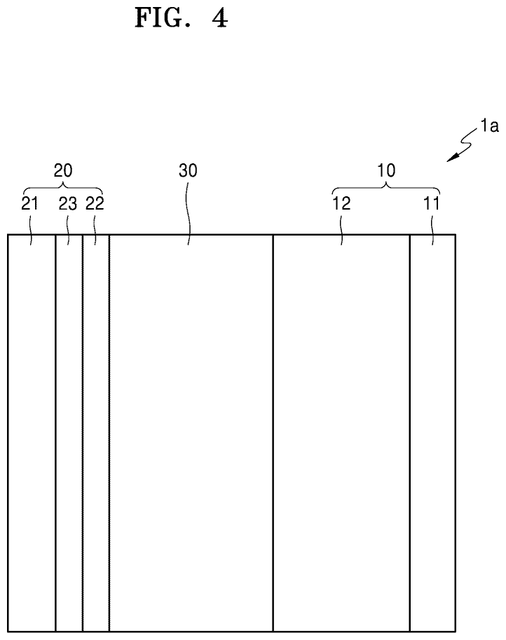

As shown in FIG. 3, a thin film 24 may be formed on the surface of the negative electrode current collector 21. The thin film 24 may include an element that is able to form an alloy with lithium. Elements that are able to form an alloy with lithium may include, for example, gold, silver, zinc, tin, indium, silicon, aluminum, and bismuth. The thin film 24 may be composed of one of these metals or may be composed of several types of alloys. By the presence of the thin film 24, the precipitation form of the metal layer 23 shown in FIG. 4 may be further flattened, and the characteristics of the all-solid secondary battery 1 may be further improved.

The thickness of the thin film 24 may be from about 1 nanometer (nm) to about 500 nm, but is not limited thereto. When the thickness of the thin film 24 is in the above range, the function of the thin film 24 is sufficient and the amount of lithium precipitated in the negative electrode layer is suitable, such that the characteristics of the all-solid secondary batteries 1 and 1 a are excellent. The thin film 24 may be formed on the negative electrode current collector 21 by, for example, vacuum deposition, sputtering, or plating.

### Method of Preparing a Solid Electrolyte

A method of preparing a solid electrolyte according to another embodiment may include preparing a raw material of one or more of a metal nitrate or a hydrate thereof; mechanically milling the raw material to provide a precursor mixture; and molding the precursor mixture to prepare the solid electrolyte.

The method of preparing the solid electrolyte may easily prepare solid ion conductors at low temperature, the solid ion conductors having excellent ion conductivity, electrochemical stability over a wide potential window when applied as a solid electrolyte in an electrochemical device, and enabling reversible development of the designed positive electrode capacity.

The metal of the metal nitrate in the raw material may be one or more of an M metal or an M′ metal, wherein the M metal may be a monovalent cationic metal, and the M′ metal may be one or more of a divalent, trivalent, tetravalent, pentavalent or hexavalent cationic metal. Examples of the metal nitrate or the hydrate thereof include one or more of La(NO₃)₃, La(NO₃)₃·6H₂O, LiNO₃, NaNO₃, KNO₃, RbNO₃, CsNO₃, FrNO₃, Ce(NO₃)₃, Ce(NO₃)₃·6H₂O, Pr(NO₃)₃, Pr(NO₃)₃·6H₂O, Nd(NO₃)₃, Nd(NO₃)₃·6H₂O, Pm(NO₃)₃, Pm(NO₃)₃·6H₂O, Sm(NO₃)₃, Sm(NO₃)₃·6H₂O, Eu(NO₃)₃, Eu(NO₃)₃·6H₂O, Ga(NO₃)₃, Ga(NO₃)₃·6H₂O, Tb(NO₃)₃, Tb(NO₃)₃·6H₂O, Dy(NO₃)₃, Dy(NO₃)₃·6H₂O, Ho(NO₃)₃, Ho(NO₃)₃·5H₂O, Er(NO₃)₃, Er(NO₃)₃·5H₂O, Tm(NO₃)₃, Tm(NO₃)₃·5H₂O, Tm(NO₃)₃·6H₂O, Yb(NO₃)₃, Yb(NO₃)₃·5H₂O, Lu(NO₃)₃, Lu(NO₃)₃·5H₂O, Lu(NO₃)₃·6H₂O, Sc(NO₃)₃, Sc(NO₃)₃·6H₂O, Y(NO₃)₃, Y(NO₃)₃·6H₂O, Ti(NO₃)₄, Zr(NO₃)₄, Hf(NO₃)₄, V(NO₃)₃, Nb(NO₃)₃, Nb(NO₃)₃·6H₂O, Ta(NO₃)₃, Al(NO₃)₃, Al(NO₃)₃·9H₂O, or In(NO₃)₃.

The method may further include adding a metal compound different than the metal nitrate or the hydrate thereof to the raw material and mixing, wherein the metal compound may be represented by formula MaX, wherein X may be a monovalent, divalent, trivalent, tetravalent or pentavalent anionic element or a polyatomic anion comprising the monovalent, divalent, trivalent, tetravalent or pentavalent anionic element, X is other than F⁻, C⁻, Br⁻, or I⁻, and a may be an integer of 1 to 5. Examples of the metal compound include one or more of Li₃PO₄, Li₂O, Li₂SO₄, LiN(SO₃CF₃)₂, LiOH, Li₂CO₃, Li(BO₃)₃, LiTiO₃, LiTaO₃, Na₃PO₄, Na₂O, Na₂SO₄, NaN(SO₃CF₃)₂, NaOH, Na₂CO₃, Na(BO₃)₃, NaTiO₃, NaTaO₃, K₃PO₄, K₂O, K₂SO₄, KN(SO₃CF₃)₂, KOH, K₂CO₃, K(BO₃)₃, KTiO₃, KTaO₃, Rb₃PO₄, Rb₂O, Rb₂SO₄, RbN(SO₃CF₃)₂, RbOH, Rb₂CO₃, Rb(BO₃)₃, RbTiO₃, RbTaO₃, Cs₃PO₄, CS₂O, CS₂SO₄, CsN(SO₃CF₃)₂, CsOH, CS₂CO₃, Cs(BO₃)₃, CsTiO₃, CsTaO₃, Fr₃PO₄, Fr₂O, Fr₂SO₄, FrN(SO₃CF₃)₂, FrOH, Fr₂CO₃, Fr(BO₃)₃, FrTiO₃, or FrTaO₃.

The metal nitrate or the hydrate thereof, or the metal nitrate or the hydrate thereof and a metal compound different than the metal nitrate or the hydrate thereof may be contacted with each other in an appropriate amount, for example, a stoichiometric amount, to prepare a raw material. Mechanical milling of the raw material is performed to prepare a mixture.

The mechanical milling may be performed by ball milling, airjet milling, bead milling, roll milling, a hand milling, high energy ball milling, planetary mill ball milling, stirred ball milling, vibrating milling, mechanofusion milling, shaker milling, planetary milling, attritor milling, disk milling, shape milling, nauta milling, nobilta milling, high speed mixing, or a combination thereof. For example, the mechanical milling may be planetary milling and may be performed at room temperature. After performing the mechanical milling, molding of the mixture may be further included.

After the mechanical milling, resting of the resultant mixture may be further included before molding or further manipulations. For example, the resultant mixture may be rested at room temperature for about 1 to about 10 minutes.

Hereinafter, examples and comparative examples of the disclosure will be described. However, the following examples are only examples of this disclosure, and this disclosure is not limited to the following examples.

### EXAMPLES

### Mixed Solid Ion Conductors

### Example 1: Preparation of Mixed Solid Ion Conductor of La(NO₃)₃, Li₃PO₄, 2LiNO₃, and Li₂O

La(NO₃)₃, Li₃PO₄, LiNO₃, and Li₂O at a stoichiometric ratio of 1:1:2:1 were added to a mortar and mixed for 2 minutes to provide a raw material. Using a planetary mill (Pulverisette 7 premium line) with zirconia (yttria-stabilized zirconia, YSZ) balls with a diameter of 10 millimeters (mm), the cycle of mixing the raw material for 15 minutes at 500 revolutions per minute (rpm) and resting for 5 minutes was repeated 12 times for 3 hours to obtain a precursor mixture. The precursor mixture was placed in a pelletizer with a diameter of 1 inch, and a weight of 5 tons was applied for 2 minutes using uniaxial pressure to prepare mixed solid ion conductor pellets of La(NO₃)₃, Li₃PO₄, 2LiNO₃, and Li₂O, in the form of circular disks.

### Example 2: Preparation of Mixed Solid Ion Conductor of La(NO₃)₃, Li₃PO₄, 3LiNO₃, and Li₂O

Mixed solid ion conductor pellets of La(NO₃)₃, Li₃PO₄, LiNO₃, and Li₂O were prepared in the same manner as in Example 1, except that La(NO₃)₃, Li₃PO₄, LiNO₃, and Li₂O were adjusted to a stoichiometric ratio of 1:1:3:1 in the mortar.

### Example 3: Preparation of Mixed Solid Ion Conductor of La(NO₃)₃, 2Li₃PO₄, 2LiNO₃, and Li₂O

Mixed solid ion conductor pellets of La(NO₃)₃, 2Li₃PO₄, 2LiNO₃, and Li₂O were prepared in the same manner as in Example 1, except that La(NO₃)₃, Li₃PO₄, LiNO₃, and Li₂O were adjusted to a stoichiometric ratio of 1:1:2:1 in the mortar.

### Example 4: Preparation of Mixed Solid Ion Conductor of La(NO₃)₃, 3Li₃PO₄, 2LiNO₃, and Li₂O

Mixed solid ion conductor pellets of La(NO₃)₃, 3Li₃PO₄, 2LiNO₃, and Li₂O were prepared in the same manner as in Example 1, except that La(NO₃)₃, Li₃PO₄, LiNO₃, and Li₂O were adjusted to a stoichiometric ratio of 1:3:2:1 in the mortar.

### Example 5: Preparation of Mixed Solid Ion Conductor of La(NO₃)₃, Li₃PO₄, and Li₂O

Mixed solid ion conductor pellets of La(NO₃)₃, Li₃PO₄, and Li₂O were prepared in the same manner as in Example 1, except that La(NO₃)₃, Li₃PO₄, and Li₂O were adjusted to a stoichiometric ratio of 1:1:1 in the mortar.

### Example 6: Preparation of Mixed Solid Ion Conductor of La(NO₃)₃, Li₃PO₄, and 3Li₂O

Mixed solid ion conductor pellets of La(NO₃)₃, Li₃PO₄, and 3Li₂O were prepared in the same manner as in Example 1, except that La(NO₃)₃, Li₃PO₄, and Li₂O were adjusted to a stoichiometric ratio of 1:1:3 in the mortar.

### Example 7: Preparation of Mixed Solid Ion Conductor of La(NO₃)_{3, 3}Li₃PO₄, and Li₂O

Mixed solid ion conductor pellets of La(NO₃)_{3, 3}Li₃PO₄, and Li₂O were prepared in the same manner as in Example 1, except that La(NO₃)₃, Li₃PO₄, and Li₂O were adjusted to a stoichiometric ratio of 1:3:1 in the mortar.

### Example 8: Preparation of Mixed Solid Ion Conductor of Al(NO₃)₃, Li₃PO₄, and 2Li₃NO₃

Mixed solid ion conductor pellets of Al(NO₃)₃, Li₃PO₄, and 2Li₃NO₃ were prepared in the same manner as in Example 1, except that Al(NO₃)₃, Li₃PO₄, and Li₃NO₃ were adjusted to a stoichiometric ratio of 1:1:2 in the mortar.

### Example 9: Preparation of Mixed Solid Ion Conductor of La(NO₃)₃, Li₂SO₄, 2LiNO₃, and Li₂O

Mixed solid ion conductor pellets of La(NO₃)₃, Li₂SO₄, 2LiNO₃, and Li₂O were prepared in the same manner as in Example 1, except that La(NO₃)₃, Li₂SO₄, LiNO₃, and Li₂O were adjusted to a stoichiometric ratio of 1:1:2:1 in the mortar.

### Example 10: Preparation of Mixed Solid Ion Conductor of La(NO₃)₃ and 2LiNO₃

Mixed solid ion conductor pellets of La(NO₃)₃ and 2LiNO₃ were prepared in the same manner as in Example 1, except that La(NO₃)₃ and LiNO₃ were adjusted to a stoichiometric ratio of 1:2 in the mortar.

### Comparative Example 1: Preparation of solid ion conductor of Li₃PO₄

Solid ion conductor pellets of Li₃PO₄ were prepared in the same manner as in Example 1, except that Li₃PO₄ was added to the mortar, and a precursor was obtained to prepare the solid ion conductor pellets.

### Comparative Example 2: Preparation of Solid Ion Conductor of LiNO₃

Solid ion conductor pellets of LiNO₃ were prepared in the same manner as in Example 1, except that LiNO₃ was added to the mortar and a precursor was obtained to prepare the solid ion conductor pellets.

### Comparative Example 3: Preparation of Solid Ion Conductor of Li₂O

Solid ion conductor pellets of LiNO₃ were prepared in the same manner as in Example 1, except that Li₂O was added to the mortar and a precursor was obtained to prepare the solid ion conductor pellets.

### All-Solid Secondary Battery

### Example 11: Preparation of all-Solid Secondary Battery

### Preparation of Negative Electrode Layer

A 10 μm-thick copper current collector was placed on the bottom of a tubular cell case with an inner diameter of 13 mm, and a 20 μm-thick indium (In)-deposited foil was sequentially placed on a side of the copper current collector to prepare a negative electrode layer.

### Preparation of Negative Electrode Layer/Solid Electrolyte Layer Laminate

On the negative electrode layer, 70 milligrams (mg) of solid ion conductor pellets of Li₆PS₅CI (Mitusi, S33) were placed as a first solid electrolyte layer and pressure was evenly distributed. On the first solid electrolyte layer, 10 mg of the mixed solid ion conductor pellets of La(NO₃)₃, Li₃PO₄, 2LiNO₃, and Li₂O prepared in Example 1 were placed as a second solid electrolyte layer and pressure was evenly distributed. Afterwards, 250 megapascal (MPa) was applied at 25° C. using cold isotactic pressing (CIP) to prepare a laminate of copper current collector layer/indium (In) layer/first solid electrolyte layer of Li₆PS₅CI/second solid electrolyte layer of La(NO₃)₃, Li₃PO₄, 2LiNO₃, and Li₂O (thickness: about 30 μm).

### Preparation of Positive Electrode Layer

LiNi_{0.9}Co_{0.07}Mn_{0.03}O₂ (NCM) as a positive electrode active material, the mixed solid ion conductor pellets prepared in Example 1 as a solid electrolyte, and carbon nanofibers (CNFs) as a conductive material were mixed at a mass ratio of 85:23:1.

Preparation of all-Solid Secondary Battery

The positive electrode layer was placed on the negative electrode layer/solid electrolyte layer laminate and a weight of 4 tons was applied for 2 minutes to prepare a torque-cell-type all-solid secondary battery.

### Examples 12 to 20: Preparation of all-Solid Secondary Batteries

An all-solid secondary battery was prepared in the same manner as in Example 11, except that the mixed solid ion conductor pellets prepared in Examples 2 to 10, respectively were used as the second solid electrolyte layer in the preparation of the negative electrode layer/solid electrolyte layer laminate, and as the solid electrolyte in the preparation of positive electrode layer.

### Comparative Examples 4 to 6: Preparation of all-Solid Secondary Batteries

All-solid secondary batteries were prepared in the same manner as in Example 11, except that the mixed solid ion conductor pellets prepared in Comparative Examples 1 to 3, respectively, were used as the second solid electrolyte layer in the preparation of the negative electrode layer/solid electrolyte layer laminate, and as the solid electrolyte in the preparation of positive electrode layer.

### Evaluation Example 1: Flexibility Test

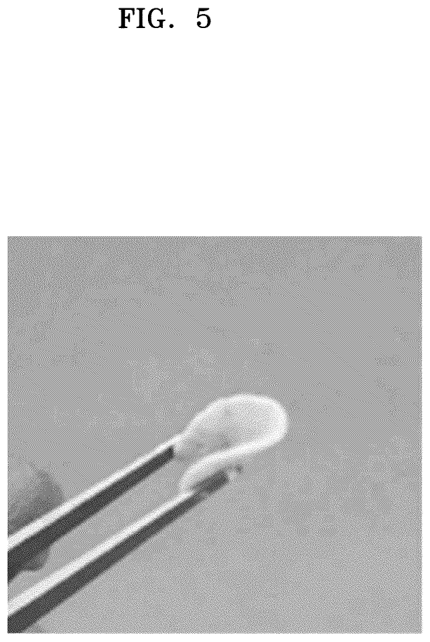

A flexibility test was performed on the mixed solid ion conductor of La(NO₃)₃, Li₃PO₄, 2LiNO₃, and Li₂O prepared in Example 1. The flexibility test was performed by pinching and bending the mixed solid ion conductor with tweezers. The results are shown in FIG. 5.

Referring to FIG. 5, it can be seen that the mixed solid ion conductor prepared in Example 1 is easily bent even when a slight force is applied.

### Evaluation Example 2: XRD Experiment

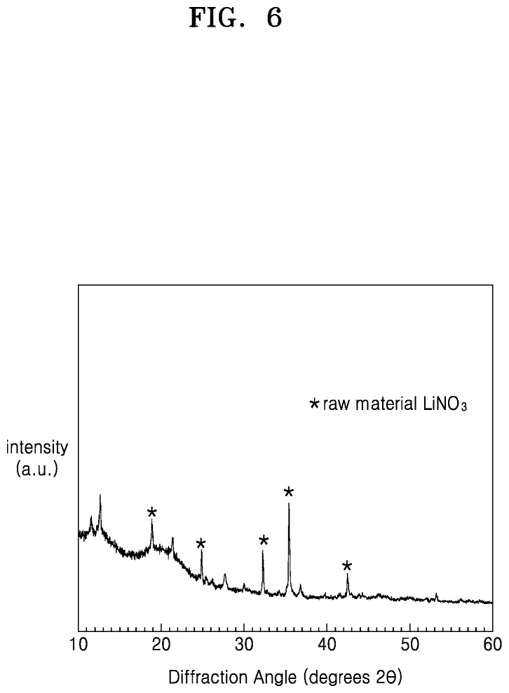

An XRD spectrum experiment using CuKα rays was performed on the mixed solid ion conductor of La(NO₃)₃, Li₃PO₄, 2LiNO₃, and Li₂O prepared in Example 1. The XRD spectrum experiment was conducted at one degree per minute (1°/min) with a diffraction angle 2θ ranging from 10° to 60°. The results are shown in FIG. 6.

Referring to FIG. 6, the mixed solid ion conductor prepared in Example 1 had a major peak in the region where the diffraction angle 2Θ is 34° to 36°, and a minor peak in the region where the diffraction angle 2Θ is 17° to 19°, 24° to 26°, 31° to 33°, and 42° to 44°, respectively. Here, the major peak refers to a peak with the maximum intensity, and the minor peak refers to a peak with a smaller intensity compared to the major peak. This was the same as the XRD spectrum of LiNO₃, the raw material for the mixed solid ion conductor prepared in Example 1, but no peaks appeared for the remaining metal compound starting materials.

From this, it may be confirmed that the mixed solid ion conductor prepared in Example 1 includes an amorphous phase.

### Evaluation Example 3: Interfacial Resistance Experiment

A lithium foil with a thickness of 8 mm was placed on a side of the mixed solid ion conductor pellets prepared in Example 1, and a lithium electrode was attached by applying 250 MPa at 25° C. by cold isotactic pressing (CIP). A lithium electrode was attached to the opposite side of the pellets in the same manner to prepare a lithium symmetric cell with a solid electrolyte/lithium structure of the lithium/mixed solid ion conductor pellets. Current collectors were placed on each lithium electrode disposed on both sides of the pellets, and while sealing the symmetric cell, a portion of the current collectors protruded outside the sealed symmetric cell and was used as an electrode terminal. The interfacial resistance of the pellets was measured using the prepared symmetric cell.

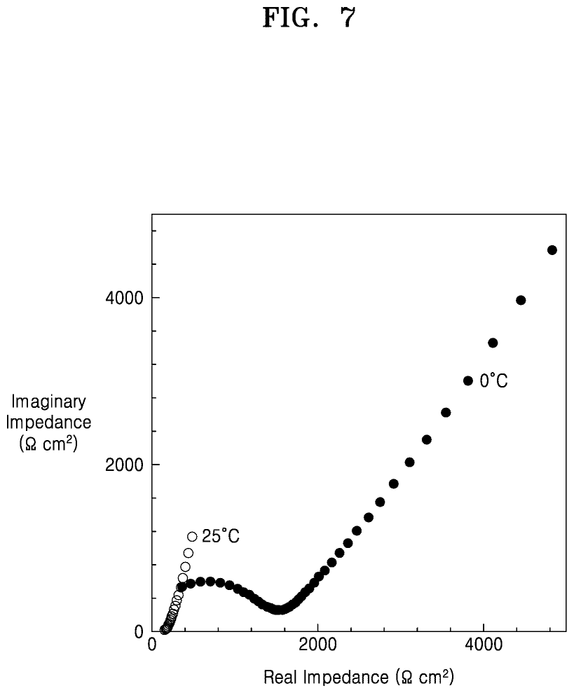

The impedance of the symmetric cell was measured by 2-probe method using Biologic VMP3 as an impedance analyzer. Impedance measurements were conducted in a dry room atmosphere of −60° C. or less with an amplitude of 200 millivolts (mV), a frequency in the range of 1 hertz (Hz) to 1 megahertz (MHz), and a dew point of 25° C. and 0° C. Interfacial resistance was measured from the size of the arc of the Nyquist plot for the impedance measurement results. The results are shown in FIG. 7.

In FIG. 7, the resistance at 0° C. of the mixed solid ion conductor prepared in Example 1 was 1520 Ω·cm² or less in a semicircular shape. However, the interfacial resistance of the mixed solid ion conductor prepared in Example 1 at 25° C. decreased due to an increase in temperature and did not appear in a semicircular shape, so the resistance corrected to a straight line was 150 Ω·cm² or less.

### Evaluation Example 4: Ion Conductivity and Activation Energy Experiment

Mixed solid ion conductor pellets with a thickness of about 1000 μm prepared in Example 1 were prepared. Platinum (Pt) paste with a thickness of 20 nm was deposited on both sides of the mixed solid ion conductor pellets by sputtering to form platinum (Pt) electrodes. Wires were connected to the platinum (Pt) electrodes on both sides of the specimen, and analysis was performed using electrochemical impedance spectroscopy (EIS).

The EIS analysis was performed with an amplitude of approximately 10 mV and a frequency ranging from 1 Hz to 106 Hz. The impedance of the pellets was measured at room temperature (25° C.) by the 2-probe method using a multi-channel test module (potentiostat/galvanostat and a 1455 frequency response analyzer (FRA) multi-channel test module, Solatron Analytical, UK) as an impedance analyzer. Resistance values were obtained from the arc of the Nyquist plot for the impedance measurement results, and ion conductivity was calculated by correcting the electrode area and pellet thickness from the resistance values. The results are shown in Table 1.

TABLE 1

| | (Mixed) solid ion | Metal nitrate | Ion conductivity |
|---|---|---|---|
| | conductor composition | amount* (wt %) | (Scm⁻¹) |
| Example 1 | La(NO₃)₃ + Li₃PO₄ + 2LiNO₃ + Li₂O | 76 | 1.5 × 10⁻³ |
| Example 2 | La(NO₃)₃ + Li₃PO₄ + 3LiNO₃ + Li₂O | 78 | 1.2 × 10⁻³ |
| Example 3 | La(NO₃)₃ + 2Li₃PO₄ + 2LiNO₃ + Li₂O | 69 | 5.3 × 10⁻⁴ |
| Example 4 | La(NO₃)₃ + 3Li₃PO₄ + 2LiNO₃ + Li₂O | 60 | 1.4 × 10⁻⁴ |
| Example 5 | La(NO₃)₃ + Li₃PO₄ + Li₂O | 72 | 5.8 × 10⁻⁵ |
| Example 6 | La(NO₃)₃ + Li₃PO₄ + 3Li₂O | 65 | 1.5 × 10⁻⁴ |
| Example 7 | La(NO₃)₃ + 3LiNO₃ + Li₂O | 95 | 5.1 × 10⁻⁴ |
| Example 8 | Al(NO₃)₃ + Li₃PO₄ + 2Li₃NO₃ | 75 | 2.4 × 10⁻⁴ |
| Example 9 | La(NO₃)₃ + Li₂SO₄ + 2LiNO₃ + Li₂O | 77 | 8.3 × 10⁻⁴ |
| Example 10 | La(NO₃)₃ + 2LiNO₃ | 100 | 8.3 × 10⁻⁴ |
| Comparative | Li₃PO₄ | 0 | 2.8 × 10⁻¹⁰ |
| Example 1 | | | |
| Comparative | LiNO₃ | 100 | 2.3 × 10⁻⁹ |
| Example 2 | | | |
| Comparative | Li₂O | 0 | 2.2 × 10⁻⁸ |
| Example 3 | | | |

*Based on the total weight of mixed solid ion conductor

Referring to Table 1, the ion conductivity of the mixed solid ion conductor prepared in Examples 1 to 10 was 5.8×10⁻⁵ Scm⁻¹ or greater with a maximum of 1.5×10⁻³ Scm⁻¹. The amount of the metal nitrate in the mixed solid ion conductor prepared in Examples 1 to 10 was 60 wt % to 100 wt % based on the total weight of the mixed solid ion conductor. In comparison, the ion conductivity of the solid ion conductors prepared in Comparative Examples 1 to 3 was 2.2×10⁻⁸ Scm⁻¹ or less.

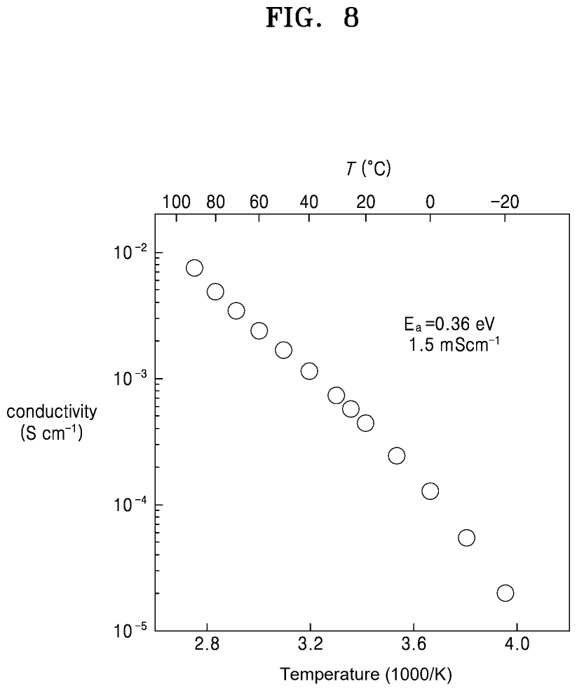

In addition, when measuring the EIS, the activation energy (Ea) value for conductivity was calculated from the results measured by changing the temperature of the chamber in which each specimen was loaded. Ea was calculated from the slope value by converting the conductivity values measured at each temperature in the section of 273 to 398 kelvin (K) into the Arrhenius plot (Ln (σT) vs. 1/T) of Equation 1 below. Here, the conductivity refers to ion conductivity. The results are shown in FIG. 8.

$$σ T = A exp ( Ea / RT ) \qquad Equation 1$$

In Equation 1,Ea is the activation energy, T represents the absolute temperature, A represents the pre-exponential factor, R represents the gas constant, and σ represents the conductivity.

Referring to FIG. 8, the activation energy of the mixed solid ionic conductor prepared in Example 1 was 0.36 eV. The activation energy of the mixed solid ion conductor prepared in Example 1 is similar to that of the sulfide solid electrolyte.

### Evaluation Example 5: Initial Charge/Discharge Experiments

The all-solid secondary battery prepared in Example 11 was subjected to charge/discharge experiments in a constant-temperature bath at 25° C. as follows.

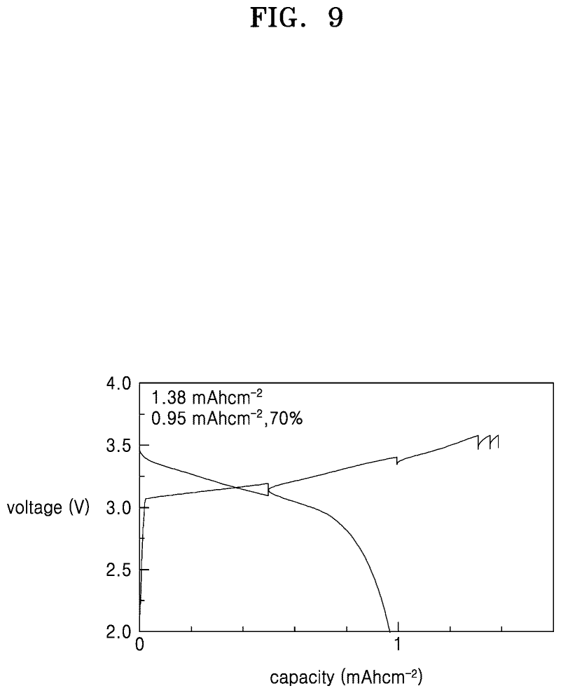

Each all-solid secondary battery was charged at a constant current of 0.1 coulombs (C) and a constant voltage of 4.2 V until the battery voltage reached 4.2 V and the current value reached 0.1 C. Discharging was performed at a constant current of 0.1 C until the battery voltage reached 2.0 V. The results of the initial charge/discharge experiments are shown in FIG. 9. In addition, the discharge capacity obtained from the experimental results was divided by the charge capacity and multiplied by 100, and the value obtained was taken as Coulombic efficiency (%).

Referring to FIG. 9, the discharge capacity of the all-solid secondary battery prepared in Example 11 was 0.95 mAh cm². Additionally, the Coulombic efficiency of the all-solid secondary battery prepared in Example 11 was about 70%.

The experiments confirmed that the initial charge/discharge performance of the all-solid secondary battery including the mixed solid ion conductor prepared in Example 1 is stable.

The solid electrolyte according to an aspect may include a mixed solid ion conductor including a metal nitrate or a hydrate thereof, wherein the metal of the metal nitrate is one or more of an M metal or an M′ metal, the M metal is a monovalent cationic metal, and the M′ metal is one or more of a divalent, a trivalent, a tetravalent, a pentavalent or a hexavalent cationic metal. The solid electrolyte may provide an electrochemical device that not only has excellent ion conductivity and flexibility, but also has electrochemical stability.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A solid electrolyte comprising:
a mixed solid ion conductor including a metal nitrate or a hydrate thereof,
wherein a metal of the metal nitrate is one or more of an M metal or an M′ metal,
the M metal is a monovalent cationic metal, and
the M′ metal is one or more of a divalent cationic metal, a trivalent cationic metal, a tetravalent cationic metal, a pentavalent cationic metal, or a hexavalent cationic metal.

2. The solid electrolyte of claim 1,
wherein the M′ metal is one or more of La, Ce, Pr, Nd, Pm, Sm, Eu, Gd, Tb, Dy, Ho, Er, Tm, Yb, Lu, Sc, Y, Ti, Zr, Hf, V, Nb, Ta, Al, Ga, or In.

3. The solid electrolyte of claim 1,
wherein the metal nitrate or the hydrate thereof has a melting point of about 0° C. to about 100° C.

4. The solid electrolyte of claim 1,
wherein the metal nitrate or the hydrate thereof comprises one or more of La(NO₃)₃, La(NO₃)₃·6H₂O, LiNO₃, NaNO₃, KNO₃, RbNO₃, CsNO₃, FrNO₃, Ce(NO₃)₃, Ce(NO₃)₃·6H₂O, Pr(NO₃), Pr(NO₃)₃·6H₂O, Nd(NO₃)₃, Nd(NO₃)₃·6H₂O, Pm(NO₃)₃, Pm(NO₃)₃·6H₂O, Sm(NO₃)₃, Sm(NO₃)₃·6H₂O, Eu(NO₃)₃, Eu(NO₃)₃·6H₂O, Ga(NO₃)₃, Ga(NO₃)₃·6H₂O, Tb(NO₃)₃, Tb(NO₃)₃·6H₂O, Dy(NO₃)₃, Dy(NO₃)₃·6H₂O, Ho(NO₃)₃, Ho(NO₃)₃·5H₂O, Er(NO₃)₃, Er(NO₃)₃·5H₂O, Tm(NO₃)₃, Tm(NO₃)₃·5H₂O, Tm(NO₃)₃·6H₂O, Yb(NO₃)₃, Yb(NO₃)₃·5H₂O, Lu(NO₃)₃, Lu(NO₃)₃·5H₂O, Lu(NO₃)₃·6H₂O, Sc(NO₃)₃, Sc(NO₃)₃·6H₂O, Y(NO₃)₃, Y(NO₃)₃·6H₂O, Ti(NO₃)₄, Zr(NO₃)₄, Hf(NO₃)₄, V(NO₃)₃, Nb(NO₃)₃, Nb(NO₃)₃·6H₂O, Ta(NO₃)₃, Al(NO₃)₃, Al(NO₃)₃·9H₂O, In(NO₃)₃, Li₂La(NO₃)₅, Li₂Ce(NO₃)₅, Li₂Pr(NO₃)₅, Li₂Nd(NO₃)s, Li₂Pm(NO₃)₅, Li₂Sm(NO₃)₅, Li₂Eu(NO₃)₅, Li₂Ga(NO₃)₅, Li₂Tb(NO₃)₅, Li₂Dy(NO₃)₅, Li₂Ho(NO₃)₅, Li₂Er(NO₃)₅, Li₂Tm(NO₃)₅, Li₂Tm(NO₃)₅, Li₂Yb(NO₃)₅, Li₂Lu(NO₃)₅, Li₂Sc(NO₃)₅, Li₂Y(NO₃)₅, Li₂V(NO₃)₅, Li₂Nb(NO₃)₅, Li₂Ta(NO₃)₅, Li₂Al(NO₃)₅, or Li₂In(NO₃)₅.

5. The solid electrolyte of claim 1,
wherein the metal nitrate has a crystal structure belonging to a Pnnm space group.

6. The solid electrolyte of claim 5,
wherein a distance between lithium and oxygen in the crystal structure is about 2.0 angstroms to about 3.0 angstroms.

7. The solid electrolyte of claim 1,
wherein an amount of the metal nitrate or the hydrate thereof is about 50 weight percent to about 100 weight percent, based on a total weight of the mixed solid ion conductor.

8. The solid electrolyte of claim 1,
further comprising a metal compound different than the metal nitrate or the hydrate thereof,
wherein the metal compound is represented by formula MₐX,
X is a monovalent, divalent, trivalent, tetravalent or pentavalent anionic element or a polyatomic anion comprising the monovalent, divalent, trivalent, tetravalent or pentavalent anionic element, wherein X is other than F⁻, Cl⁻, Br⁻, or I⁻, and a is an integer of 1 to 5.

9. The solid electrolyte of claim 8,
wherein X comprises O²⁻, (PO₄)⁻, (SO₄)⁻, [N(SO₃CF₃)₂]⁻, OH⁻, (CO₃)⁻, (BO₃)⁻, (TiO₃)⁻, or (TaO₃)⁻.

10. The solid electrolyte of claim 8,
wherein the metal compound comprises one or more of Li₃PO₄, Li₂O, Li₂SO₄, LiN(SO₃CF₃)₂, LiOH, Li₂CO₃, Li(BO₃)₃, LiTiO₃, LiTaO₃, Na₃PO₄, Na₂O, Na₂SO₄, NaN(SO₃CF₃)₂, NaOH, Na₂CO₃, Na(BO₃)₃, NaTiO₃, NaTaO₃, K₃PO₄, K₂O, K₂SO₄, KN(SO₃CF₃)₂, KOH, K₂CO₃, K(BO₃)₃, KTiO₃, KTaO₃, Rb₃PO₄, Rb₂O, Rb₂SO₄, RbN(SO₃CF₃)₂, RbOH, Rb₂CO₃, Rb(BO₃)₃, RbTiO₃, RbTaO₃, Cs₃PO₄, CS₂O, CS₂SO₄, CsN(SO₃CF₃)₂, CsOH, CS₂CO₃, Cs(BO₃)₃, CsTiO₃, CsTaO₃, Fr₃PO₄, Fr₂O, Fr₂SO₄, FrN(SO₃CF₃)₂, FrOH, Fr₂CO₃, Fr(BO₃)₃, FrTiO₃, or FrTaO₃.

11. The solid electrolyte of claim 1,
wherein the mixed solid ion conductor comprises an amorphous phase.

12. The solid electrolyte of claim 1,
wherein the mixed solid ion conductor has an ion conductivity of about 5×10⁻⁵ siemens per centimeter to about 2×10⁻³ siemens per centimeter at 25° C.

13. An electrochemical device comprising:
a positive electrode layer;
a negative electrode layer, and
a solid electrolyte layer between the positive electrode layer and the negative electrode layer, wherein one or more of the positive electrode layer, the negative electrode layer, or the solid electrolyte layer comprises the solid electrolyte of claim 1.

14. The electrochemical device of claim 13,
wherein the positive electrode layer comprises a positive electrode active material and the solid electrolyte, and
the solid electrolyte layer includes the solid electrolyte and further includes a solid electrolyte comprising one or more of a sulfide solid electrolyte, an oxide solid electrolyte, or a polymer solid electrolyte.

15. The electrochemical device of claim 14,
wherein the oxide solid electrolyte comprises one or more of Li_{1+x+y}AlₓTi₂₋ₓSi_{y}P_{3-y}O₁₂wherein 0<x<2 and 0≤y<3, BaTiO₃, Pb(ZrₐTi₁₋ₐ)O₃ wherein 0≤a≤1, Pb₁₋ₓLaₓZr_{1-y}Ti_{y}O₃ wherein 0≤x<1 and 0≤y<1, Pb(Mg₃Nb_{2/3})O₃—PbTiO₃, HfO₂, SrTiO₃, SnO₂, CeO₂, Na₂O, MgO, NiO, CaO, BaO, ZnO, ZrO₂, Y₂O₃, Al₂O₃, TiO₂, SiO₂, Li₃PO₄, LiₓTi_{y}(PO₄)₃ wherein 0<x<2 and 0<y<3, LiₓAl_{y}Ti_{z}(PO₄)₃ wherein 0<x<2, 0<y<1, and 0<z<3, Li_{1+x+y}(AlₐGa₁₋ₐ)ₓ(Ti_{b}Ge_{1-b})₂₋ₓSi_{y}P_{3-y}O₁₂ wherein 0≤x≤1, 0≤y≤1, 0≤a≤1, and 0≤b≤1, LiₓLa_{y}TiO₃ wherein 0<x<2 and 0<y<3, Li₂O, LiOH, Li₂CO₃, LiAlO₂, Li₂O—Al₂O₃—SiO₂—P₂O₅ —TiO₂—GeO₂, or Li₃₊ₓLa₃M₂O₁₂ wherein M═Te, Nb, or Zr, and x is an integer of 1 to 10.

16. The electrochemical device of claim 14,
wherein the sulfide solid electrolyte comprises a compound represented by the following Formula 4:
LiₐM′5ₓPS_{y}M′6_{z}M′7_{w} Formula 4
wherein in Formula 4, M′5 is one or more metal elements other than Li and selected from Groups 1 to 15 of the Periodic Table of the Elements, and M′6 is one or more elements selected from Group 17 of the Periodic Table of the Elements,
M′7 is SOₙ, 4≤a≤8, 0≤x<1, 3≤y≤7, 0<z≤5, 0≤w<2, and 1.5≤n≤5.

17. The electrochemical device of claim 13,
wherein the electrochemical device is an electrochemical cell, a storage battery, a super capacitor, a fuel cell, a sensor, or a color-changing device.

18. A method of preparing a solid electrolyte, the method comprising: preparing a raw material of one or more of a metal nitrate or a hydrate thereof;
mechanically milling the raw material to provide a mixture; and
molding the mixture to prepare the solid electrolyte of claim 1.

19. The method of claim 18,
further comprising adding a metal compound different than the metal nitrate or the hydrate thereof to the raw material and mixing,
wherein the metal compound is represented by formula MaX,
X is a monovalent, divalent, trivalent, tetravalent or pentavalent element or a polyatomic anion comprising the monovalent, divalent, trivalent, tetravalent or pentavalent anionic element, and a is an integer of 1 to 5.

20. The method of claim 18,
wherein mechanically milling comprises one or more of ball milling, airjet milling, bead milling, roll milling, hand milling, high energy ball milling, planetary mill ball milling, stirred ball milling, vibrating milling, mechanofusion milling, shaker milling, planetary milling, attritor milling, disk milling, shape milling, nauta milling, nobilta milling, or high speed mixing.
